(19) United States
(12) Patent Application Publication
(10) Pub. No.: US 2025/0088849 A1
(43) Pub. Date: Mar. 13, 2025

(54) CREDENTIAL TRANSMISSION METHOD AND APPARATUS, COMMUNICATION DEVICE, AND STORAGE MEDIUM

(71) Applicant: BEIJING XIAOMI MOBILE SOFTWARE CO., LTD., Beijing (CN)

(72) Inventor: Wei HONG, Beijing (CN)

(73) Assignee: BEIJING XIAOMI MOBILE SOFTWARE CO., LTD., Beijing (CN)

(21) Appl. No.: 18/580,591

(22) PCT Filed: Jul. 19, 2021
(86) PCT No.: PCT/CN2021/107150

§ 371 Date: Jan. 18, 2024

(51) Int. Cl. H04W 12/06; H04W 12/10; H04W 60/04; H04W 76/10; H04W 76/20

(52) U.S. Cl. CPC H04W 12/068; H04W 12/10; H04W 60/04; H04W 76/10; H04W 76/20

(57) ABSTRACT

A credential transmission method includes receiving, by a terminal, first indication information sent by a base station. The first indication information is used for indicating that a user plane security protection operation of a data radio bearer (DRB) of the terminal is requested to be activated or not to be activated. The DRB is at least used for bearing a credential required by the terminal for accessing a stand-alone non-public network (SNPN).

### CROSS-REFERENCE TO RELATED APPLICATIONS

The present application is the U.S. national phase of International Application No. PCT/CN2021/107150, filed on Jul. 19, 2021, the disclosure of which is incorporated herein by reference in its entirety for all purposes.

### BACKGROUND OF THE INVENTION

In order to enhance support for a terminal to access non-public networks (NPNs), a stand-alone NPN credential needs to be provided to the terminal. The credential is used for primary authentication to enable the terminal to access the desired SNPN after the authentication is passed. Herein, the terminal should be allowed to access an onboarding network (ONN) before the credential is provided to the terminal. The credential is different from an ordinary user service flow transmitted at the user plane. The credential is highly sensitive data, and security protection needs to performed on the credential. Otherwise, the terminal will not be able to pass the authentication to access the desired SNPN or may be tricked into accessing a malicious SNPN.

### SUMMARY OF THE INVENTION

The present disclosure relates to, but is not limited to, the field of wireless communication technology, and in particular relates to a credential transmission method and apparatus, a communication device, and a storage medium. Embodiments of the present disclosure provide a credential transmission method and apparatus, a communication device, and a storage medium.

According to a first aspect of the embodiments of the present disclosure, a credential transmission method is provided. The method is performed by a terminal, and includes receiving first indication information sent by a base station.

The first indication information is used for indicating that a user plane security protection operation of a data radio bearer (DRB) of the terminal is requested to be activated or not to be activated. The DRB is at least used for bearing a credential required by the terminal for accessing a stand-alone non-public network (SNPN).

According to a second aspect of the embodiments of the present disclosure, a credential transmission method is provided. The method is performed by a base station, and includes sending to a terminal first indication information.

The first indication information is used for indicating that a user plane security protection operation of a DRB of the terminal is requested to be activated or not to be activated. The DRB is at least used for bearing a credential required by the terminal for accessing an SNPN.

According to a third aspect of the embodiments of the present disclosure, a credential transmission method is provided. The method is performed by a first core network device, and includes receiving a registration request message sent by a base station.

A registration type of the registration request message is set to be a predetermined registration type. The predetermined registration type is used for indicating that the registration request message is used for a terminal to log into an onboarding network (ONN) to obtain a credential required by the terminal for accessing an SNPN.

According to a fourth aspect of the embodiments of the present disclosure, a credential transmission method is provided. The method is performed by a second core network device, and includes receiving a protocol data unit (PDU) session establishment request message sent by a first core network device.

The PDU session establishment request message at least includes information of a digital data network (DNN), and the information of the DNN is used for indicating a DNN for obtaining a credential required by a terminal for accessing an SNPN.

According to a fifth aspect of the embodiments of the present disclosure, a communication device is provided. The communication device includes a processor and a memory configured to store an executable instruction executable by the processor.

The processor, when being used for executing the executable instruction, is configured to implement the method described in any embodiment of the present disclosure.

According to a sixth aspect of the embodiments of the present disclosure, a computer storage medium is provided. The computer storage medium stores a computer- executable program. The computer-executable program, when executed by a processor, implements the method described in any embodiment of the present disclosure.

It is to be understood that both the foregoing general description and the following detailed description are exemplary and explanatory only and are not restrictive of the present disclosure.

### BRIEF DESCRIPTION OF THE DRAWINGS

The accompanying drawings illustrated here are provided for further understanding of the present disclosure and constitute a part of the present disclosure. The illustrative examples of the present disclosure and their descriptions are used to explain the present disclosure and do not constitute an undue limitation of the present disclosure. In the accompanying drawings:

FIG. 1 is a schematic structural diagram of a wireless communication system illustrated according to an example or embodiment.

FIG. 2 is a schematic diagram of a network architecture illustrated according to an example or embodiment.

FIG. 3 is a schematic flow diagram of a credential transmission method illustrated according to an example or embodiment.

FIG. 4 is a schematic flow diagram of a credential transmission method illustrated according to an example or embodiment.

FIG. 5 is a schematic flow diagram of a credential transmission method illustrated according to an example or embodiment.

FIG. 6 is a schematic flow diagram of a credential transmission method illustrated according to an example or embodiment.

FIG. 7 is a schematic flow diagram of a credential transmission method illustrated according to an example or embodiment.

FIG. 8 is a schematic flow diagram of a credential transmission method illustrated according to an example or embodiment.

FIG. 9 is a schematic flow diagram of a credential transmission method illustrated according to an example or embodiment.

FIG. 10 is a schematic flow diagram of a credential transmission method illustrated according to an example or embodiment.

FIG. 11 is a schematic flow diagram of a credential transmission method illustrated according to an example or embodiment.

FIG. 12 is a schematic flow diagram of a credential transmission method illustrated according to an example or embodiment.

FIG. 13 is a schematic flow diagram of a credential transmission method illustrated according to an example or embodiment.

FIG. 14 is a schematic flow diagram of a credential transmission method illustrated according to an example or embodiment.

FIG. 15 is a schematic flow diagram of a credential transmission method illustrated according to an example or embodiment.

FIG. 16 is a schematic flow diagram of a credential transmission method illustrated according to an example or embodiment.

FIG. 17 is a schematic flow diagram of a credential transmission method illustrated according to an example or embodiment.

FIG. 18 is a schematic flow diagram of a credential transmission method illustrated according to an example or embodiment.

FIG. 19 is a schematic flow diagram of a credential transmission method illustrated according to an example or embodiment.

FIG. 20 is a schematic flow diagram of a credential transmission method illustrated according to an example or embodiment.

FIG. 21 is a schematic flow diagram of a credential transmission method illustrated according to an example or embodiment.

FIG. 22 is a schematic flow diagram of a credential transmission method illustrated according to an example or embodiment.

FIG. 23 is a schematic flow diagram of a credential transmission method illustrated according to an example or embodiment.

FIG. 24 is a schematic flow diagram of a credential transmission method illustrated according to an example or embodiment.

FIG. 25 is a schematic flow diagram of a credential transmission method illustrated according to an example or embodiment.

FIG. 26 is a schematic flow diagram of a credential transmission method illustrated according to an example or embodiment.

FIG. 27 is a schematic flow diagram of a credential transmission method illustrated according to an example or embodiment.

FIG. 28 is a schematic flow diagram of a credential transmission method illustrated according to an example or embodiment.

FIG. 29 is a schematic diagram of a credential transmission apparatus illustrated according to an example or embodiment.

FIG. 30 is a schematic diagram of a credential transmission apparatus illustrated according to an example or embodiment.

FIG. 31 is a schematic diagram of a credential transmission apparatus illustrated according to an example or embodiment.

FIG. 32 is a schematic diagram of a credential transmission apparatus illustrated according to an example or embodiment.

FIG. 33 is a schematic structural diagram of a terminal illustrated according to an example or embodiment.

FIG. 34 is a block diagram of a base station illustrated according to an example or embodiment.

### DETAILED DESCRIPTION

Examples or embodiments are described herein in detail, examples of which are represented in the accompanying drawings. When the following description relates to the accompanying drawings, the same numerals in different accompanying drawings indicate the same or similar elements unless otherwise indicated. The embodiments described in the following examples or embodiments do not represent all embodiments consistent with the embodiments of the present disclosure. Rather, they are only examples of devices and methods that are consistent with some aspects of embodiments of the present disclosure as detailed in the appended claims.

The terminology used in the embodiments of the present disclosure is used solely for the purpose of describing particular embodiments and is not intended to limit the embodiments of the present disclosure. The singular forms of “a” and “the” used in the present disclosure and the appended claims are also intended to include the majority form, unless the context clearly indicates other meanings. It should also be understood that the term “and/or” as used herein refers to and includes any or all possible combinations of one or more of the associated listed items.

It should be understood that although the terms “first,” “second,” “third,” etc. may be used in the embodiments of the present disclosure to describe various types of information, such information should not be limited to these terms. These terms are only used to distinguish the same type of information from one another. For example, without departing from the scope of the embodiments of the present disclosure, the first information may also be referred to as the second information, and similarly, the second information may also be referred to as the first information. Depending on the context, the phrase “if” as used herein may be interpreted as “at . . . ,” “when . . . ,” or “in response to determining.”

For the purpose of simplicity and ease of understanding, the terms “greater than” or “less than” are used herein to characterize the magnitude relationship. However, it may be understood to those skilled in the art that the term “greater than” also covers the meaning of “greater than or equal to,” and the term “less than” also covers the meaning of “less than or equal to.”

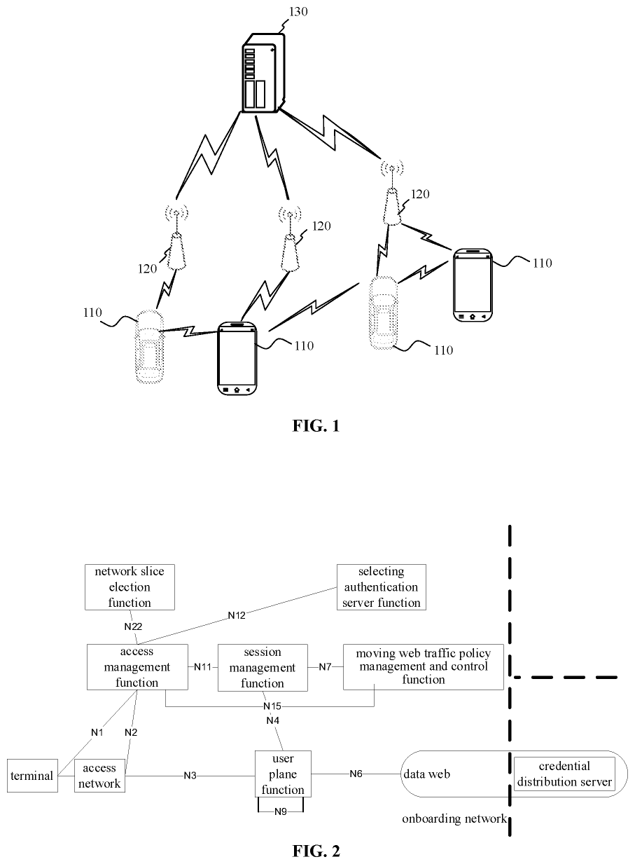

In related arts, protection mechanisms for ensuring security of credential transmission need be to introduced in order to ensure the security of the credential transmission. Referring to FIG. 1, a schematic structural diagram of a wireless communication system provided in an embodiment of the present disclosure is shown. As shown in FIG. 1, the wireless communication system is a communication system based on mobile communication technology, and the wireless communication system may include a plurality of user devices 110 and a plurality of base stations 120.

The user device 110 may be a device that provides voice and/or data connectivity to a user. The user device 110 may communicate with one or more core networks via a radio access network (RAN). The user device 110 may be an IoT user device, such as a sensor device, a mobile phone, or a computer with an IoT user device. For example, the user device 110 may be a fixed, portable, pocket, handheld, computer built-in, or vehicle-mounted device. For example, the user device 110 may be a station (STA), subscriber unit, subscriber station, mobile station, mobile, remote station, access point, remote terminal, access terminal, user terminal, user agent, user device, or user equipment. Alternatively, the user device 110 may also be a device of an unmanned aerial vehicle. Alternatively, the user device 110 may also be a vehicle-mounted device, such as a trip computer with a wireless communication function or a wireless user device 110 externally connected to a trip computer. Alternatively, the user device 110 may also be a road side device, such as a street light, signal light, or other road side devices with a wireless communication function.

The base station 120 may be a network-side device in the wireless communication system. The wireless communication system may be the 4th generation (4G) mobile communication system, also known as the long term evolution (LTE) system. Alternatively, the wireless communication system may also be a 5G system, also known as a new radio (NR) system or a 5G NR system. Alternatively, the wireless communication system may be the next generation system of the 5G system. The access network in the 5G system may be called the new generation-radio access network (NG-RAN).

The base station 120 may be an evolved base station (eNB) used in a 4G system. Alternatively, the base station 120 may also be a base station (gNB) with a centralized distributed architecture in a 5G system. When adopting the centralized distributed architecture, the base station 120 typically includes a central unit (CU) and at least two distributed units (DUs). The central unit is provided with a protocol stack of a packet data convergence protocol (PDCP) layer, a radio link control (RLC) layer, and a media access control (MAC) layer. The distributed unit is provided with a protocol stack of a physical (PHY) layer. The embodiments of the present disclosure do not limit the specific implementations of the base station 120.

A wireless connection may be established between the base station 120 and the user device 110 via a wireless air interface. In a different implementation, the wireless air interface is based on the 4th generation (4G) mobile communication network technology standard. Alternatively, the wireless air interface is based on the 5th generation (5G) mobile communication network technology standard, for example, the wireless air interface is a new air interface. Alternatively, the wireless air interface may also be based on the next generation mobile communication network technology standard of 5G.

In some embodiments, an end to end (E2E) connection may also be established between user devices 110. For example, scenarios such as vehicle to vehicle (V2V) communication, vehicle to infrastructure (V2I) communication, and vehicle to pedestrian (V2P) communication in vehicle to everything (V2X) communication.

Herein, the above-described user device may be considered a terminal device in the following embodiments.

In some embodiments, the above-described wireless communication system may also include a network management device 130.

Several base stations 120 are respectively connected to the network management device 130. In these embodiments, the network management device 130 may be a core network device in the wireless communication system, for example, the network management device 130 may be a mobility management entity (MME) in the evolved packet core (EPC). Alternatively, the network management device may also be other core network devices, such as a service gateway (SGW), public data network gateway (PGW), policy and charging rules function (PCRF), or home subscriber server (HSS). The implementation forms of the network management device 130 are not limited by the embodiments of the present disclosure.

In order to facilitate the understanding of those skilled in the art, the embodiments of the present disclosure enumerate a plurality of implementations to clearly illustrate the technical solutions of the embodiments of the present disclosure. Of course, those skilled in the art may understand that the plurality of embodiments provided in the embodiments of the present disclosure may be performed separately, or may be performed together with the methods of other embodiments in the embodiments of the present disclosure after combination, or may be performed together with some methods in other related arts, either separately or in combination. The present disclosure embodiments do not make limitations to this.

In order to better understand the technical solutions disclosed in the embodiments of the present disclosure, application scenarios of providing the credential are described:

Referring to FIG. 2, a network architecture is shown in this embodiment. Based on the network architecture, a terminal may first log into a network. A credential distribution server may then pre-configure a credential to the terminal via a user plane connection.

In an embodiment, both the terminal and the base station in the onboarding network (ONN) support access layer security to protect the Uu interface after the terminal has successfully come online. However, the activation of user plane connection security protection is not mandatory at the Uu interface, which leads to a risk of exposing the credential to threats during remote configuration of the credential via the user plane connection.

In an embodiment, the user plane connection security of the Uu interface is activated based on security policy information sent by the core network, and is set by the unified data management (UDM) or the session management function (SMF) based on a specific service requested by the terminal. The SMF determines the user plane security performing information of a protocol data unit (PDU) session based on the following information when the PDU session is established: the signed user plane security policy information that is part of the signed information received from the UDM; and the user plane security policy information configured locally in the SMF, which is used when the user plane security policy information is not provided by the UDM.

In an embodiment, the user plane security policy information indicates whether the user plane security protection should be activated at the Uu interface for all data radio bearers (DRBs) belonging to the PDU session, which is used for activating user plane encryption and/or user plane integrity protection for all DRBs belonging to the PDU session.

In an embodiment, based on the user plane security policy information provided by the SMF, the base station activates the user plane security protection for each DRB by using radio resource control (RRC) signaling if the security policy information indicates “required”. If the policy indicates “not required”, the PDU session is established without protection. If the policy indicates “recommended”, the base station may decide on its own whether or not to activate the user plane security protection. However, when the policy indicates “required” or “not required”, the base station cannot override the receipt of the user plane security policy information.

In an embodiment, the user plane security protection is continuously implemented at the Uu interface by using the DRB addition process of an RRC connection reconfiguration process. When the base station determines, based on the user plane security policy information, to activate the user plane security protection at the Uu, an indication of activating the user plane security protection is included in the RRC connection reconfiguration request. The terminal then implements the same user plane security protection based on the activation indication sent by the base station.

There are two other issues that need to be addressed in order to protect remote provisioning of a stand-alone non-public network (SNPN) credential.

1. When the terminal selects an ONN to log into and obtain the credential required to access the SNPN, the selected ONN may not be the home network of the terminal. Therefore, the UDM in the ONN may not include the user plane security policy information that the terminal has signed. This only leaves the option of having the SMF configure the user plane security policy information locally. However, how the SMF determines the security policy information for the user plane transmission of the SNPN credential is not defined and remains to be investigated.

2. Since the SMF and the base station are network nodes in the ONN, different from the network nodes in the SNPN to which the terminal request access, the SMF and the base station in the ONN may not be trusted by the SNPN and the terminal to correctly perform the security policy used for protecting the SNPN credential. In particular, in the presence of a fake or malfunctioning base station, the base station may ignore the security policy received from the SMF and deactivate the user plane security protection at the Uu interface. In the related arts, the terminal is only allowed to follow the activation indication sent by the base station to implement the user plane security protection. The terminal is unable to check whether the security activation indication as received matches with the security requirement of the PDU session as requested.

In a scenario embodiment, when a user plane PDU session needs to be established to transmit the credential, the base station may send to the terminal the activation indication used for activating the user plane security protection operation (it should be illustrated that under normal circumstances, in order to ensure the transmission security of the credential, if the base station is a trusted base station, the base station will certainly send, according to the security policy of the SMF, the activation indication to activate the terminal to perform the security protection operation, and the base station will certainly not send an activation indication that does not comply with the security policy of the SMF). After the terminal receives the activation indication, the terminal may establish a user plane PDU session and perform the user plane security protection operation to realize the secure transmission of the credential.

However, in another scenario embodiment, due to the inevitable presence of insecure factors in the network, for example, the presence of a fake base station or a malfunctioning base station (hereinafter, uniformly described as a pseudo base station), the pseudo base station, in order to realize the purpose of stealing the credential, may send to the terminal a non-activation indication (pseudo instruction) that does not activate the user plane security protection operation. After receiving the non-activation indication, the terminal, according to the existing mechanism, should comply with the activation indication sent by the base station for activating the user plane security protection operation, so as to establish the user plane PDU session and not to perform the user plane security protection operation (if following the indication of the trusted base station, the user plane security protection operation should have been required to be performed, which is equivalent to being tampered with). At this time, there is no security guarantee when using the user plane PDU session to transmit the credential. It is also a problem of the related arts.

In response to this situation of no security guarantee, technical solutions of the embodiments of the present disclosure are provided (herein, it should be illustrated that when the terminal needs to obtain the credential, the terminal is determined to have the requirement to perform the user plane security protection operation, and by default, the terminal requires to activate the user plane security protection operation).

In the present disclosure, the terminal may determine, based on the indication as received, whether to establish a PDU session and whether to perform the user plane security protection operation, i.e., if the indication as received is the activation indication for activating the user plane security protection operation, the terminal may establish the PDU session and perform the user plane security protection operation; if the indication as received is an activation indication for not activating the user plane security protection operation, the terminal may reject the RRC connection reconfiguration message, i.e., the establishment of the PDU session fails (because the terminal receives an inactivation indication, which indicates that the base station is malfunctioning, or has been attacked by the pseudo base station, or that the establishment is not allowed by the network; and at this time, not establishing the PDU session can effectively avoid the risk of the credential being stolen).

Herein, it should be illustrated that if the terminal accepts the RRC connection reconfiguration message, the user plane PDU session used for transmitting the credential may be established, and the credential is transmitted by using the user plane PDU session. If the terminal rejects the RRC connection reconfiguration message, the user plane PDU session used for transmitting the credential may not be established.

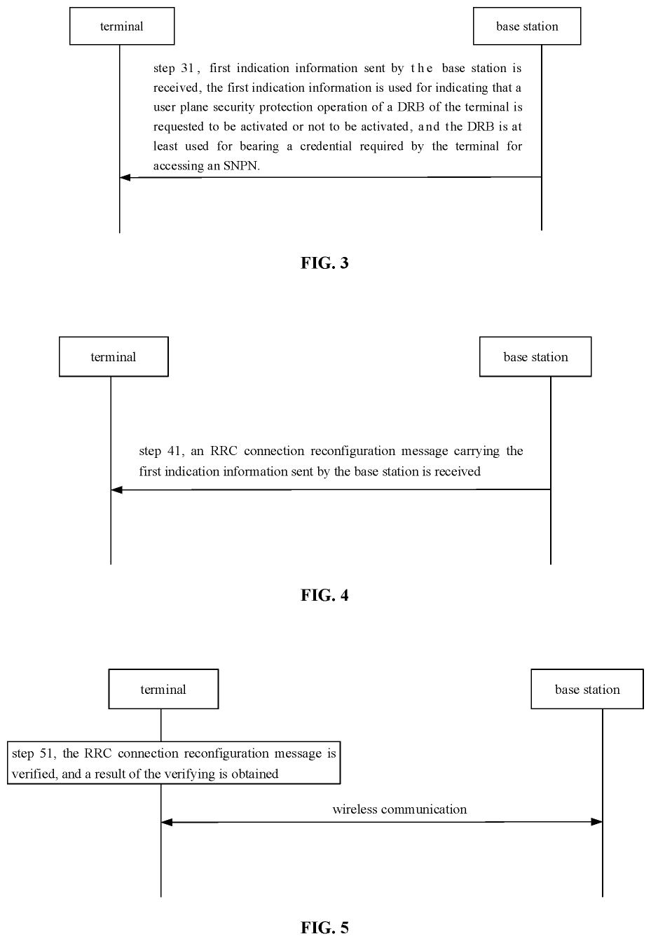

As shown in FIG. 3, a credential transmission method is provided in this embodiment. The method is performed by a terminal, and includes step 31.

At step 31, first indication information sent by a base station is received.

The first indication information is used for indicating that a user plane security protection operation of a DRB of the terminal is requested to be activated or not to be activated. The DRB is at least used for bearing a credential required by the terminal for accessing an SNPN.

Herein, the terminal may be, but is not limited to, a cell phone, a tablet, a wearable device, a vehicle-mounted terminal, a road side unit (RSU), a smart home terminal, an industrial sensor device, and/or a medical device, etc.

Herein, the base station to which the present disclosure relates may be a base station of various types, for example, a base station of a 3rd generation (3G) mobile communication network, a base station of a 4th generation (4G) mobile communication network, a base station of a 5th generation (5G) mobile communication network, or other evolved base stations. Herein, the base station may be a base station of an ONN.

In an embodiment, the user plane security protection operation includes integrity protection and/or encryption. The user plane security protection operation of the DRB of the terminal may be integrity protection and/or encryption for the credential that is required by the terminal for accessing the SNPN and is borne by the DRB.

In an embodiment, an RRC connection reconfiguration message carrying the first indication information sent by the base station may be received. Herein, the base station may send the RRC connection reconfiguration message to the terminal after the RRC security protection has been activated. In an embodiment, the RRC connection reconfiguration message is sent to the terminal after the RRC encryption and the RRC integrity protection have been activated.

In an embodiment, the RRC connection reconfiguration message carrying the first indication information sent by the base station may be received. Herein, the first indication information may be sent for a particular DRB. The first indication information may include an indication of the user plane integrity protection and/or an indication of the user plane encryption.

In an embodiment, the RRC connection reconfiguration message carrying the first indication information sent by the base station is received, herein, the first indication information indicates that the user plane security protection operation of the DRB of the terminal is requested to be activated. Based on the first indication information, for each DRB, the terminal may initiate uplink user plane integrity protection and downlink user plane authentication; and/or, based on the first indication information, for each DRB, the terminal may initiate uplink user plane encryption and downlink user plane decryption.

In an embodiment, the RRC connection reconfiguration message carrying the first indication information sent by the base station is received, herein, the first indication information indicates that the user plane security protection operation of the DRB of the terminal is requested not to be activated, and the terminal may reject the RRC connection reconfiguration message. Herein, the terminal rejecting the RRC connection reconfiguration message may be that: based on the first indication information, for each DRB, the terminal may not initiate the uplink user plane integrity protection and the downlink user plane authentication; and, based on the first indication information, for each DRB, the terminal may not initiate the uplink user plane encryption and the downlink user plane decryption.

Herein, the user plane integrity protection may be the integrity protection for the credential borne on the DRB. The user plane encryption may be the encryption for the credential borne on the DRB. In this way, it is possible to ensure that the credential is not illegally stolen and that the transmission of the credential is secure. It should be illustrated that the user plane integrity protection may also be the integrity protection for other types of data other than the credential borne on the DRB, and the user plane encryption may also be the encryption for other types of data other than the credential borne on the DRB, which is not limited herein.

In an embodiment, after receiving the RRC connection reconfiguration message, the terminal may verify the RRC connection reconfiguration message. In response to the verifying being unsuccessful, the terminal may ignore the RRC connection reconfiguration message. In response to the verifying being successful, the terminal may perform a corresponding operation based on the indication of the first indication information in the RRC connection reconfiguration message.

In an embodiment, the RRC connection reconfiguration message carrying the first indication information sent by the base station is received, the RRC connection reconfiguration message is verified, and a result of the verifying is obtained. If the result of the verifying indicates that the verifying is successful, whether to activate the user plane security protection operation of the DRB of the terminal is determined based on the first indication information. Herein, the RRC connection reconfiguration message may be rejected in response to the first indication information indicating that the user plane security protection operation of the DRB of the terminal is requested not to be activated; or, in response to the first indication information indicating that the user plane security protection operation of the DRB of the terminal is requested to be activated, the user plane security protection operation is performed. Herein, the terminal may send an RRC connection reconfiguration completion message to the base station after the terminal determines that the user plane security protection operation is performed. Herein, the RRC connection reconfiguration completion message is used for indicating that the activation of the user plane security protection operation of the DRB of the terminal has been completed.

In an embodiment, before the base station of the ONN sends the first indication information to the terminal, the terminal may send second indication information to the base station during an RRC connection establishment process. The second indication information is used for indicating that an RRC connection being established is used for the terminal to log into the ONN. The base station, after receiving the second indication information, may select the access control and mobility management function (AMF) entity used for supporting the terminal to log into the ONN. Herein, it should be illustrated that the AMF entity is configured with AMF login configuration data. The AMF login configuration data includes digital data network (DNN) information used for obtaining the credential, and/or information restricting the terminal to only be capable of requesting to obtain the credential.

In an embodiment, after the base station selects the AMF entity, the terminal may send a registration request message to the base station when the terminal requires to register to the ONN. Herein, a registration type of the registration request message is set to be a predetermined registration type, and the predetermined registration type is used for indicating that the registration request message is used for logging into the ONN to obtain the credential. For example, the predetermined registration type is the registration type of “log into SNPN”. After receiving the registration request message, the base station may send the registration request message to the AMF, and the AMF, after receiving the registration request message, may initiate a procedure for authenticating the terminal to an authentication service function (AUSF) entity in the ONN. Herein, the AMF login configuration data may restrict that the terminal is only capable of requesting the distribution of the SNPN credential at the user plane.

In an embodiment, after the terminal has successfully logged into the ONN, if the terminal requires to receive the SNPN credential from the ONN via the user plane, a PDU session establishment procedure may be initiated. Herein, initiating the PDU session establishment procedure may be to send a first PDU session establishment request message to the base station in the ONN, herein, the first PDU session establishment request message includes DNN information used for obtaining the SNPN credential. Herein, it should be illustrated that in an embodiment, the terminal may be pre-configured with the DNN information, herein, the provisioning server for providing the SNPN credential is located in the DNN indicated by the DNN information, or the DNN information is provided to the terminal by the ONN during the login process. In an embodiment, the trigger for the terminal to initiate the PDU session establishment procedure to retrieve the SNPN credential is dependent on the terminal, e.g., the PDU session establishment procedure is initiated based on the information input to the terminal by the user. After receiving the first PDU session establishment request message sent by the terminal, the base station may send the first PDU session establishment request message to the AMF.

In an embodiment, after receiving the first PDU session establishment request message sent by the base station, the AMF may determine, based on a DNN determined according to the DNN information in the first PDU session establishment request message and a DNN determined according to the DNN information in the AMF login configuration data, whether the terminal requests an establishment of a PDU session for obtaining the credential. In an embodiment, in response to the DNN determined according to the DNN information in the first PDU session establishment request message not matching with the DNN determined according to the DNN information in the AMF login configuration data, the first PDU session establishment request message is rejected. In another embodiment, in response to the DNN determined according to the DNN information in the first PDU session establishment request message matching with the DNN determined according to the DNN information in the AMF login configuration data, a session management function (SMF) entity that is connected to the DNN is selected.

In an embodiment, after the SMF entity connected to the DNN is selected, a second PDU session establishment request message may be sent to the SMF entity. The second PDU session establishment request message includes information of the DNN and creation indication information for creating a PDU session for obtaining the credential. After receiving the second PDU session establishment request message, the SMF entity may configure, based on the creation indication information, the security policy information of the PDU session to be created for obtaining the credential to be indicative of a first target state. The first target state is a state indicative of performing the user plane security protection. Herein, the first target state may be a “require” state that requires the security protection for the DRB of the terminal.

In an embodiment, after connecting to the SMF entity of the DNN, a third PDU session establishment request message may be sent to the SMF. The third PDU session establishment request message includes information of the DNN and does not include the creation indication information for creating the PDU session used for obtaining the credential. After receiving the third PDU session establishment request message, the SMF entity may determine the security policy information of the PDU session based on a DNN determined according to the DNN information in the third PDU session establishment request message and a DNN determined according to the DNN information configured in the SMF. In an embodiment, in response to the DNN determined according to the information of the DNN in the third PDU session establishment request message matching with the DNN determined according to the DNN information configured in the SMF, the security policy information of the PDU session to be created for obtaining the credential may be configured to be indicative of a first target state. Alternately, in another embodiment, in response to the DNN determined according to the information of the DNN in the third PDU session establishment request message not matching with the DNN determined according to the DNN information configured in the SMF, the security policy information of the PDU session to be created for obtaining the credential may be configured to be indicative of a second target state. Herein, the first target state is a state indicative of performing the user plane security protection.

In the embodiments of the present disclosure, the first indication information sent by the base station is received. The first indication information is used for indicating that the user plane security protection operation of the DRB of the terminal is requested to be activated or not to be activated, and the DRB is at least used for bearing a credential required by the terminal for accessing an SNPN. Herein, the terminal, upon receiving the first indication information sent by the base station, can activate the user plane security protection operation of the DRB of the terminal or not activate the user plane security protection operation of the DRB of the terminal based on the first indication information. In this way, reliability of the transmission of the credential of the SNPN by using the DRB can be enhanced to ensure the security of the credential transmission.

It should be illustrated that the methods provided in the embodiments of the present disclosure may be performed separately or together with some of the methods in the embodiments of the present disclosure or some of the methods in the related arts, which can be understood by those skilled in the art.

As shown in FIG. 4, a credential transmission method is provided in this embodiment. The method is performed by a terminal, and includes step 41.

At step 41, an RRC connection reconfiguration message carrying the first indication information sent by the base station is received.

In an embodiment, the RRC connection reconfiguration message carrying the first indication information sent by the base station may be received. Herein, the base station may send the RRC connection reconfiguration message to the terminal after the RRC security protection has been activated. In an embodiment, the RRC connection reconfiguration message is sent to the terminal after the RRC encryption and the RRC integrity protection have been activated.

In an embodiment, the RRC connection reconfiguration message carrying the first indication information sent by the base station may be received. Herein, the first indication information may be sent for a particular DRB. The first indication information may include an indication of the user plane integrity protection and/or an indication of the user plane encryption.

In an embodiment, the RRC connection reconfiguration message carrying the first indication information sent by the base station is received, herein, the first indication information indicates that the user plane security protection operation of the DRB of the terminal is requested to be activated. Based on the first indication information, for each DRB, the terminal may initiate the uplink user plane integrity protection and the downlink user plane authentication; and/or, based on the first indication information, for each DRB, the terminal may initiate the uplink user plane encryption and the downlink user plane decryption.

It should be illustrated that the methods provided in the embodiments of the present disclosure may be performed separately or together with some of the methods in the embodiments of the present disclosure or some of the methods in the related arts, which can be understood by those skilled in the art.

As shown in FIG. 5, a credential transmission method is provided in this embodiment. The method is performed by a terminal, and includes step 51.

At step 51, the RRC connection reconfiguration message is verified, and a result of the verifying is obtained.

In an embodiment, in response to the verifying of the RRC connection reconfiguration message being unsuccessful, the terminal may ignore the RRC connection reconfiguration message. In response to the verifying of the RRC connection reconfiguration message being successful, the terminal may perform a corresponding operation based on the first indication information in the RRC connection reconfiguration message. If the result of the verifying indicates that the verifying is successful, whether to activate the user plane security protection operation of the DRB of the terminal is determined based on the first indication information. In an embodiment, the RRC connection reconfiguration message is rejected in response to the first indication information indicating that the user plane security protection operation of the DRB of the terminal is requested not to be activated. In another embodiment, the user plane security protection operation is performed in response to the first indication information indicating that the user plane security protection operation of the DRB of the terminal is requested to be activated.

It should be illustrated that the methods provided in the embodiments of the present disclosure may be performed separately or together with some of the methods in the embodiments of the present disclosure or some of the methods in the related arts, which can be understood by those skilled in the art.

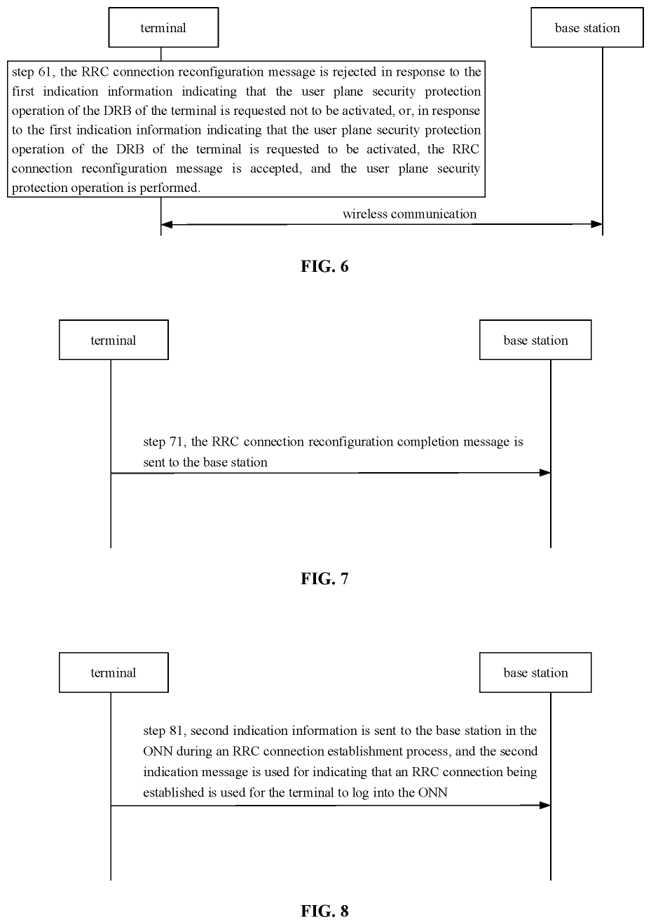

As shown in FIG. 6, a credential transmission method is provided in this embodiment. The method is performed by a terminal, and includes step 61.

At step 61, the RRC connection reconfiguration message is rejected in response to the first indication information indicating that the user plane security protection operation of the DRB of the terminal is requested not to be activated.

Alternatively, in response to the first indication information indicating that the user plane security protection operation of the DRB of the terminal is requested to be activated, the RRC connection reconfiguration message is accepted, and the user plane security protection operation is performed.

Herein, in response to rejecting the RRC connection reconfiguration message, the terminal does not establish the PDU session used for the credential transmission and does not perform the user plane security protection operation.

Herein, performing the user plane security protection operation may be performing the user plane security protection operation based on the generated user plane integrity protection key K_{UPint} and the user plane encryption key K_{UPenc}.

It should be illustrated that the methods provided in the embodiments of the present disclosure may be performed separately or together with some of the methods in the embodiments of the present disclosure or some of the methods in the related arts, which can be understood by those skilled in the art.

As shown in FIG. 7, a credential transmission method is provided in this embodiment. The method is performed by a terminal, and includes step 71.

At step 71, the RRC connection reconfiguration completion message is sent to the base station.

In an embodiment, the RRC connection reconfiguration message carrying the first indication information sent by the base station is received, the RRC connection reconfiguration message is verified, and a result of the verifying is obtained. If the result of the verifying indicates that the verifying is successful, whether to activate the user plane security protection operation of the DRB of the terminal is determined based on the first indication information. Herein, the RRC connection reconfiguration message may be rejected in response to the first indication information indicating that the user plane security protection operation of the DRB of the terminal is requested not to be activated; or, in response to the first indication information indicating that the user plane security protection operation of the DRB of the terminal is requested to be activated, the user plane security protection operation is performed. Herein, the terminal may send the RRC connection reconfiguration completion message to the base station after the terminal determines that the user plane security protection operation is performed. Herein, the RRC connection reconfiguration completion message is used for indicating that the activation of the user plane security protection operation of the DRB of the terminal has been completed.

It should be illustrated that the methods provided in the embodiments of the present disclosure may be performed separately or together with some of the methods in the embodiments of the present disclosure or some of the methods in the related arts, which can be understood by those skilled in the art.

As shown in FIG. 8, a credential transmission method is provided in this embodiment. The method is performed by a terminal, and includes step 81.

At step 81, second indication information is sent to the base station in the ONN during an RRC connection establishment process. The second indication message is used for indicating that an RRC connection being established is used for the terminal to log into the ONN.

In an embodiment, before the base station of the ONN sends the first indication information to the terminal, the terminal may send the second indication information to the base station during the RRC connection establishment process. The second indication information is used for indicating that the RRC connection being established is used for the terminal to log into the ONN. The base station, after receiving the second indication information, may select the AMF entity used for supporting the terminal to log into the ONN. Herein, it should be illustrated that the AMF entity is configured with AMF login configuration data. The AMF login configuration data includes the DNN information used for obtaining the credential, and/or information restricting the terminal to only be capable of requesting to obtain the credential.

It should be illustrated that the methods provided in the embodiments of the present disclosure may be performed separately or together with some of the methods in the embodiments of the present disclosure or some of the methods in the related arts, which can be understood by those skilled in the art.

As shown in FIG. 9, a credential transmission method is provided in this embodiment. The method is performed by a terminal, and includes step 91.

At step 91, the registration request message is sent to the base station in response to the terminal initiating the registration to the ONN.

Herein, the registration type of the registration request message is set to be the predetermined registration type, and the predetermined registration type is used for indicating that the registration request message is used for logging into the ONN to obtain the credential.

In an embodiment, after the base station selects the AMF entity, the terminal may send the registration request message to the base station when the terminal requires to register to the ONN. Herein, the registration type of the registration request message is set to be the predetermined registration type, and the predetermined registration type is used for indicating that the registration request message is used for logging into the ONN to obtain the credential. For example, the predetermined registration type is the registration type of “log into SNPN”. After receiving the registration request message, the base station may send the registration request message to the AMF, and the AMF, after receiving the registration request message, may initiate the procedure for authenticating the terminal to the AUSF entity in the ONN. Herein, the AMF login configuration data may restrict that the terminal network is only capable of requesting the distribution of the SNPN credential at the user plane.

It should be illustrated that the methods provided in the embodiments of the present disclosure may be performed separately or together with some of the methods in the embodiments of the present disclosure or some of the methods in the related arts, which can be understood by those skilled in the art.

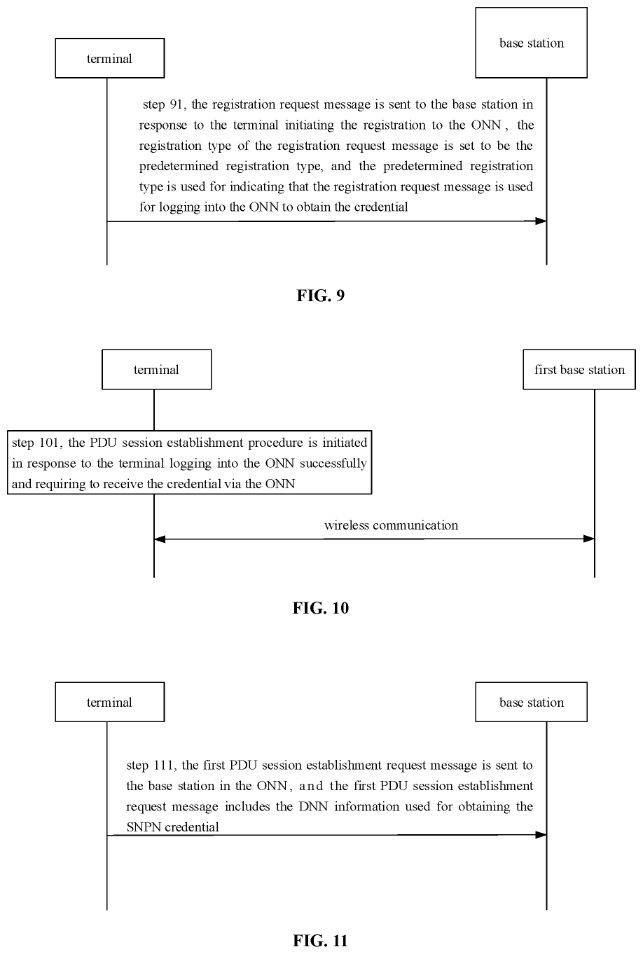

As shown in FIG. 10, a credential transmission method is provided in this embodiment. The method is performed by a terminal, and includes step 101.

At step 101, the PDU session establishment procedure is initiated in response to the terminal logging into the ONN successfully and requiring to receive the credential via the ONN.

In an embodiment, after the terminal has successfully logged into the ONN, if the terminal requires to receive the SNPN credential from the ONN via the user plane, the PDU session establishment procedure may be initiated. Herein, initiating the PDU session establishment procedure may be to send the first PDU session establishment request message to the base station in the ONN, herein, the first PDU session establishment request message includes the DNN information used for obtaining the SNPN credential. Herein, it should be illustrated that in an embodiment, the terminal may be pre-configured with the DNN information, herein, the provisioning server for providing the SNPN credential is located in the DNN indicated by the DNN information, or the DNN information is provided to the terminal by the ONN during the login process. In an embodiment, the trigger for the terminal to initiate the PDU session establishment procedure to retrieve the SNPN credential is dependent on the terminal, e.g., the PDU session establishment procedure is initiated based on the information input to the terminal by the user. After receiving the first PDU session establishment request message sent by the terminal, the base station may send the first PDU session establishment request message to the AMF.

It should be illustrated that the methods provided in the embodiments of the present disclosure may be performed separately or together with some of the methods in the embodiments of the present disclosure or some of the methods in the related arts, which can be understood by those skilled in the art.

As shown in FIG. 11, a credential transmission method is provided in this embodiment. The method is performed by a terminal, and includes step 111.

At step 111, the first PDU session establishment request message is sent to the base station in the ONN. The first PDU session establishment request message includes the DNN information used for obtaining the credential.

In an embodiment, the base station may send the first PDU session establishment request message to the AMF after receiving the first PDU session establishment request message sent by the terminal. After receiving the first PDU session establishment request message sent by the base station, the AMF may determine, based on the DNN determined according to the DNN information in the first PDU session establishment request message and the DNN determined according to the DNN information in the AMF login configuration data, whether the terminal requests an establishment of a PDU session for obtaining the credential. In an embodiment, in response to the DNN determined according to the DNN information in the first PDU session establishment request message not matching with the DNN determined according to the DNN information in the AMF login configuration data, the first PDU session establishment request message is rejected. In another embodiment, in response to the DNN determined according to the DNN information in the first PDU session establishment request message matching with the DNN determined according to the DNN information in the AMF login configuration data, the SMF entity that is connected to the DNN is selected.

It should be illustrated that the methods provided in the embodiments of the present disclosure may be performed separately or together with some of the methods in the embodiments of the present disclosure or some of the methods in the related arts, which can be understood by those skilled in the art.

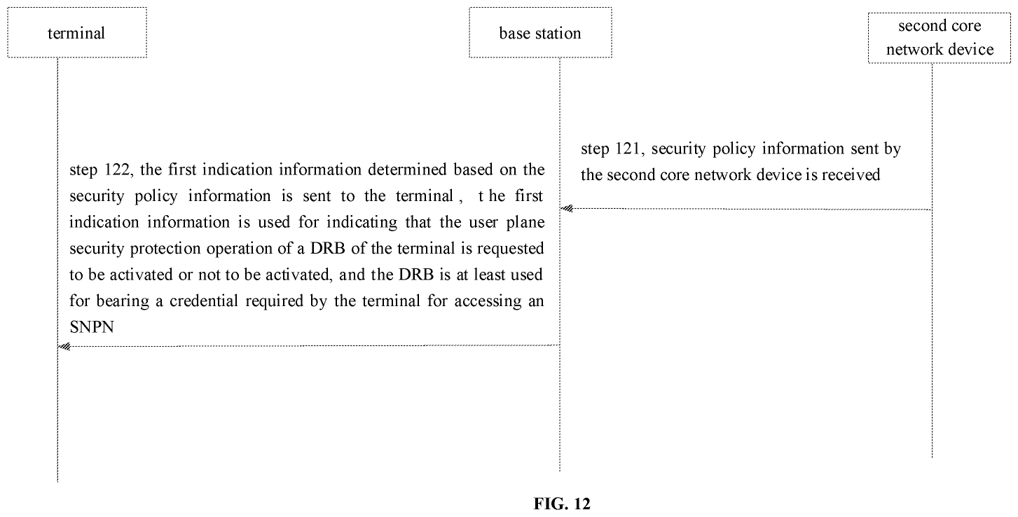

As shown in FIG. 12, a credential transmission method is provided in this embodiment. The method is performed by a base station, and includes steps 121 to 122.

At step 121, security policy information sent by a second core network device is received.

At step 122, the first indication information determined based on the security policy information is sent to the terminal.

The first indication information is used for indicating that the user plane security protection operation of a DRB of the terminal is requested to be activated or not to be activated. The DRB is at least used for bearing a credential required by the terminal for accessing an SNPN.

Herein, the terminal may be, but is not limited to, a cell phone, a tablet, a wearable device, a vehicle-mounted terminal, a road side unit (RSU), a smart home terminal, an industrial sensor device, and/or a medical device, etc.

Herein, the base station to which the present disclosure relates may be a base station of various types, for example, a base station of a 3rd generation (3G) mobile communication network, a base station of a 4th generation (4G) mobile communication network, a base station of a 5th generation (5G) mobile communication network, or other evolved base stations. Herein, the base station may be a base station of an ONN.

In an embodiment, the user plane security protection operation includes integrity protection and/or encryption. The user plane security protection operation of the DRB of the terminal may be integrity protection and/or encryption for the credential that is required by the terminal for accessing the SNPN and is borne by the DRB.

In an embodiment, an RRC connection reconfiguration message carrying the first indication information sent by the base station may be received. Herein, the base station may send the RRC connection reconfiguration message to the terminal after the RRC security protection has been activated. In an embodiment, the RRC connection reconfiguration message is sent to the terminal after the RRC encryption and the RRC integrity protection have been activated.

In an embodiment, the RRC connection reconfiguration message carrying the first indication information sent by the base station may be received. Herein, the first indication information may be sent for a particular DRB. The first indication information may include an indication of the user plane integrity protection and/or an indication of the user plane encryption.

In an embodiment, the RRC connection reconfiguration message carrying the first indication information sent by the base station is received, herein, the first indication information indicates that the user plane security protection operation of the DRB of the terminal is requested to be activated. Based on the first indication information, for each DRB, the terminal may initiate the uplink user plane integrity protection and the downlink user plane authentication; and/or, based on the first indication information, for each DRB, the terminal may initiate the uplink user plane encryption and the downlink user plane decryption.

In an embodiment, the RRC connection reconfiguration message carrying the first indication information sent by the base station is received, herein, the first indication information indicates that the user plane security protection operation of the DRB of the terminal is requested not to be activated, and the terminal may reject the RRC connection reconfiguration message. Herein, the terminal rejecting the RRC connection reconfiguration message may be that: based on the first indication information, for each DRB, the terminal may not initiate the uplink user plane integrity protection and the downlink user plane authentication; and, based on the first indication information, for each DRB, the terminal may not initiate the uplink user plane encryption and the downlink user plane decryption.

Herein, the user plane integrity protection may be the integrity protection for the credential borne on the DRB. The user plane encryption may be the encryption for the credential borne on the DRB. In this way, it is possible to ensure that the credential is not illegally stolen and that the transmission of the credential is secure. It should be illustrated that the user plane integrity protection may also be the integrity protection for other types of data other than the credential borne on the DRB, and the user plane encryption may also be the encryption for other types of data other than the credential borne on the DRB, which is not limited herein.

In an embodiment, after receiving the RRC connection reconfiguration message, the terminal may verify the RRC connection reconfiguration message. In response to the verifying being unsuccessful, the terminal may ignore the RRC connection reconfiguration message. In response to the verifying being successful, the terminal may perform a corresponding operation based on the indication of the first indication information in the RRC connection reconfiguration message.

In an embodiment, the RRC connection reconfiguration message carrying the first indication information sent by the base station is received, the RRC connection reconfiguration message is verified, and a result of the verifying is obtained. If the result of the verifying indicates that the verifying is successful, whether to activate the user plane security protection operation of the DRB of the terminal is determined based on the first indication information. Herein, the RRC connection reconfiguration message may be rejected in response to the first indication information indicating that the user plane security protection operation of the DRB of the terminal is requested not to be activated; or, in response to the first indication information indicating that the user plane security protection operation of the DRB of the terminal is requested to be activated, the user plane security protection operation is performed. Herein, the terminal may send the RRC connection reconfiguration completion message to the base station after the terminal determines that the user plane security protection operation is performed. Herein, the RRC connection reconfiguration completion message is used for indicating that the activation of the user plane security protection operation of the DRB of the terminal has been completed.

In an embodiment, before the base station of the ONN sends the first indication information to the terminal, the terminal may send the second indication information to the base station during the RRC connection establishment process. The second indication information is used for indicating that the RRC connection being established is used for the terminal to log into the ONN. The base station, after receiving the second indication information, may select the AMF entity used for supporting the terminal to log into the ONN. Herein, it should be illustrated that the AMF entity is configured with the AMF login configuration data. The AMF login configuration data includes the DNN information used for obtaining the credential, and/or the information restricting the terminal to only be capable of requesting to obtain the credential.

In an embodiment, after the base station selects the AMF entity, the terminal may send the registration request message to the base station when the terminal requires to register to the ONN. Herein, the registration type of the registration request message is set to be the predetermined registration type, and the predetermined registration type is used for indicating that the registration request message is used for logging into the ONN to obtain the credential. For example, the predetermined registration type is the registration type of “log into SNPN”. After receiving the registration request message, the base station may send the registration request message to the AMF, and the AMF, after receiving the registration request message, may initiate the procedure for authenticating the terminal to the AUSF entity in the ONN. Herein, the AMF login configuration data may restrict that the terminal is only capable of requesting the distribution of the SNPN credential at the user plane.

In an embodiment, after the terminal has successfully logged into the ONN, if the terminal requires to receive the SNPN credential from the ONN, the PDU session establishment procedure may be initiated. Herein, initiating the PDU session establishment procedure may be to send the first PDU session establishment request message to the base station in the ONN, herein, the first PDU session establishment request message includes the DNN information used for obtaining the SNPN credential. Herein, it should be illustrated that in an embodiment, the terminal may be pre-configured with the DNN information, herein, the provisioning server for providing the SNPN credential is located in the DNN indicated by the DNN information, or the DNN information is provided to the terminal by the ONN during the login process. In an embodiment, the trigger for the terminal to initiate the PDU session establishment procedure to retrieve the SNPN credential is dependent on the terminal, e.g., the PDU session establishment procedure is initiated based on the information input to the terminal by the user. After receiving the first PDU session establishment request message sent by the terminal, the base station may send the first PDU session establishment request message to the AMF.

In an embodiment, after receiving the first PDU session establishment request message sent by the base station, the AMF may determine, based on the DNN determined according to the DNN information in the first PDU session establishment request message and the DNN determined according to the DNN information in the AMF login configuration data, whether the terminal requests the establishment of the PDU session for obtaining the credential. In an embodiment, in response to the DNN determined according to the DNN information in the first PDU session establishment request message not matching with the DNN determined according to the DNN information in the AMF login configuration data, the first PDU session establishment request message is rejected. In another embodiment, in response to the DNN determined according to the DNN information in the first PDU session establishment request message matching with the DNN determined according to the DNN information in the AMF login configuration data, the SMF entity that is connected to the DNN is selected.

In an embodiment, after the SMF entity connected to the DNN is selected, the second PDU session establishment request message may be sent to the SMF entity. The second PDU session establishment request message includes the information of the DNN and the creation indication information for creating the PDU session for obtaining the credential. After receiving the second PDU session establishment request message, the SMF entity may configure, based on the creation indication information, the security policy information of the PDU session to be created for obtaining the credential to be indicative of the first target state. The first target state is a state indicative of performing the user plane security protection. Herein, the first target state may be a “require” state that requires the security protection for the DRB of the terminal.

In an embodiment, after connecting to the SMF entity of the DNN, the third PDU session establishment request message may be sent to the SMF. The third PDU session establishment request message includes the information of the DNN and does not include the creation indication information for creating the PDU session used for obtaining the credential. After receiving the third PDU session establishment request message, the SMF entity may determine the security policy information of the PDU session based on the DNN determined according to the DNN information in the third PDU session establishment request message and the DNN determined according to the DNN information configured in the SMF. In an embodiment, in response to the DNN determined according to the information of the DNN in the third PDU session establishment request message matching with the DNN determined according to the DNN information configured in the SMF, the security policy information of the PDU session to be created for obtaining the credential may be configured to be indicative of the first target state. Alternately, in another embodiment, in response to the DNN determined according to the information of the DNN in the third PDU session establishment request message not matching with the DNN determined according to the DNN information configured in the SMF, the security policy information of the PDU session to be created for obtaining the credential may be configured to be indicative of the second target state. Herein, the first target state is a state indicative of performing the user plane security protection.

It should be illustrated that the methods provided in the embodiments of the present disclosure may be performed separately or together with some of the methods in the embodiments of the present disclosure or some of the methods in the related arts, which can be understood by those skilled in the art.

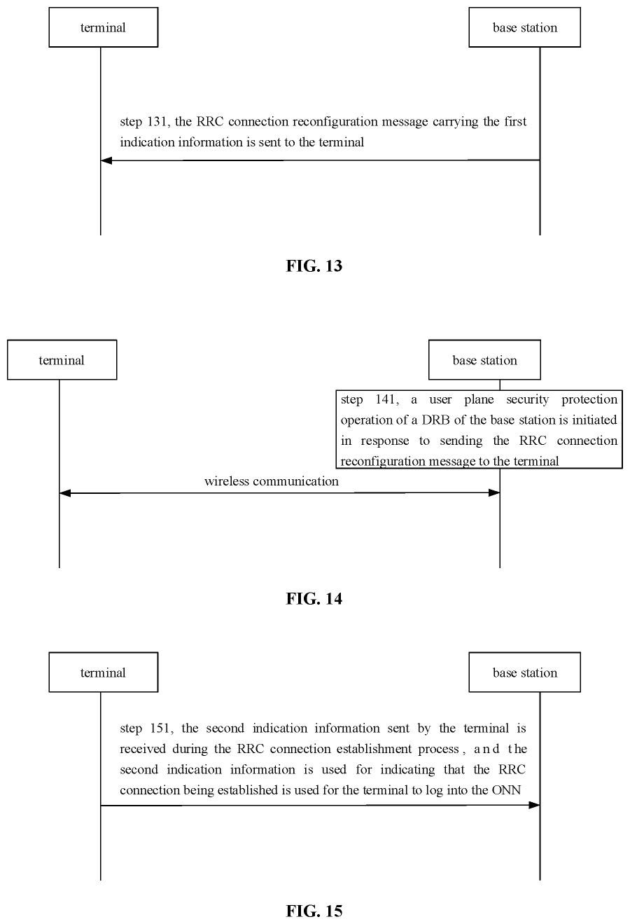

As shown in FIG. 13, a credential transmission method is provided in this embodiment. The method is performed by a base station, and includes step 131.

At step 131, the RRC connection reconfiguration message carrying the first indication information is sent to the terminal.

In an embodiment, the RRC connection reconfiguration message carrying the first indication information may be sent to the terminal. Herein, the base station may send the RRC connection reconfiguration message to the terminal after the RRC security protection has been activated. In an embodiment, the RRC connection reconfiguration message is sent to the terminal after the RRC encryption and the RRC integrity protection have been activated.

In an embodiment, the RRC connection reconfiguration message carrying the first indication information may be sent to the terminal. Herein, the first indication information may be sent for a particular DRB. The first indication information may include the indication of the user plane integrity protection and/or the indication of the user plane encryption.

In an embodiment, the RRC connection reconfiguration message carrying the first indication information may be sent to the terminal, herein, the first indication information indicates that the user plane security protection operation of the DRB of the terminal is requested to be activated. Based on the first indication information, for each DRB, the terminal may initiate the uplink user plane integrity protection and the downlink user plane authentication; and/or, based on the first indication information, for each DRB, the terminal may initiate the uplink user plane encryption and the downlink user plane decryption.

It should be illustrated that the methods provided in the embodiments of the present disclosure may be performed separately or together with some of the methods in the embodiments of the present disclosure or some of the methods in the related arts, which can be understood by those skilled in the art.

As shown in FIG. 14, a credential transmission method is provided in this embodiment. The method is performed by a base station, and includes step 141.

At step 141, a user plane security protection operation of a DRB of the base station is initiated in response to sending the RRC connection reconfiguration message to the terminal.

In an embodiment, the user plane integrity protection may be the integrity protection for the credential borne on the DRB. The user plane encryption may be the encryption for the credential borne on the DRB. In this way, it is possible to ensure that the credential is not illegally stolen and that the transmission of the credential is secure. It should be illustrated that the user plane integrity protection may also be the integrity protection for other types of data other than the credential borne on the DRB, and the user plane encryption may also be the encryption for other types of data other than the credential borne on the DRB, which is not limited herein.

It should be illustrated that the methods provided in the embodiments of the present disclosure may be performed separately or together with some of the methods in the embodiments of the present disclosure or some of the methods in the related arts, which can be understood by those skilled in the art.

As shown in FIG. 15, a credential transmission method is provided in this embodiment. The method is performed by a base station, and includes step 151.

At step 151, the second indication information sent by the terminal is received during the RRC connection establishment process. The second indication information is used for indicating that the RRC connection being established is used for the terminal to log into the ONN.

In an embodiment, before the base station of the ONN sends the first indication information to the terminal, the terminal may send the second indication information to the base station during the RRC connection establishment process. The second indication information is used for indicating that the RRC connection being established is used for the terminal to log into the ONN. The base station, after receiving the second indication information, may select the AMF entity used for supporting the terminal to log into the ONN. Herein, it should be illustrated that the AMF entity is configured with the AMF login configuration data. The AMF login configuration data includes the DNN information used for obtaining the credential, and/or the information restricting the terminal to only be capable of requesting to obtain the credential.

It should be illustrated that the methods provided in the embodiments of the present disclosure may be performed separately or together with some of the methods in the embodiments of the present disclosure or some of the methods in the related arts, which can be understood by those skilled in the art.

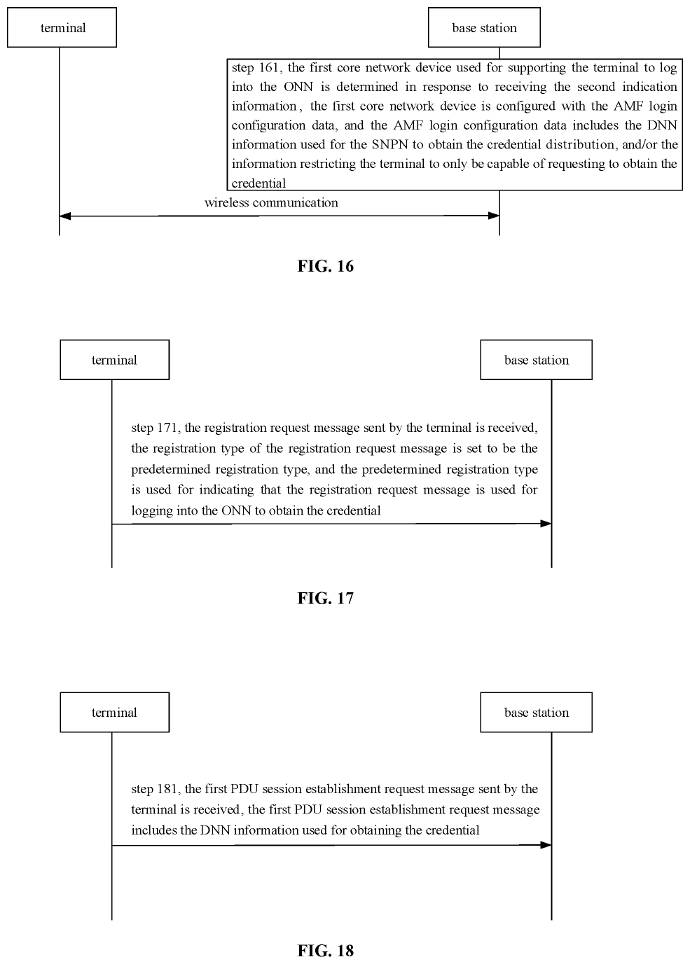

As shown in FIG. 16, a credential transmission method is provided in this embodiment. The method is performed by a base station, and includes step 161.

At step 161, the first core network device used for supporting the terminal to log into the ONN is determined in response to receiving the second indication information.

Herein, the first core network device is configured with the AMF login configuration data, and the AMF login configuration data includes the DNN information used for obtaining the credential, and/or the information restricting the terminal to only be capable of requesting to obtain the credential.

Herein, the first core network device may be an AMF.

In an embodiment, after receiving the registration request message, the base station may send the registration request message to the AMF. The AMF, after receiving the registration request message, may initiate the procedure for authenticating the terminal to the AUSF entity in the ONN. Herein, the AMF login configuration data may indicate that the terminal network is restricted to only being used for the allocation or distribution of the SNPN credential at the user plane.

It should be illustrated that the methods provided in the embodiments of the present disclosure may be performed separately or together with some of the methods in the embodiments of the present disclosure or some of the methods in the related arts, which can be understood by those skilled in the art.

As shown in FIG. 17, a credential transmission method is provided in this embodiment. The method is performed by a base station, and includes step 171.

At step 171, the registration request message sent by the terminal is received.

Herein, the registration type of the registration request message is set to be the predetermined registration type, and the predetermined registration type is used for indicating that the registration request message is used for logging into the ONN to obtain the credential.

In an embodiment, after the base station selects the AMF entity, the terminal may send the registration request message to the base station when the terminal requires to register to the ONN. Herein, the registration type of the registration request message is set to be the predetermined registration type, and the predetermined registration type is used for indicating that the registration request message is used for logging into the ONN to obtain the credential. For example, the predetermined registration type is the registration type of “log into SNPN”.

In an embodiment, the base station may also send the registration request message to the AMF.

It should be illustrated that the methods provided in the embodiments of the present disclosure may be performed separately or together with some of the methods in the embodiments of the present disclosure or some of the methods in the related arts, which can be understood by those skilled in the art.

As shown in FIG. 18, a credential transmission method is provided in this embodiment. The method is performed by a base station, and includes step 181.

At step 181, the first PDU session establishment request message sent by the terminal is received. The first PDU session establishment request message includes the DNN information used for obtaining the credential.

In an embodiment, after the terminal has successfully logged into the ONN, if the terminal requires to receive the SNPN credential from the ONN, the PDU session establishment procedure may be initiated. Herein, initiating the PDU session establishment procedure may be to send the first PDU session establishment request message to the base station in the ONN, herein, the first PDU session establishment request message includes the DNN information used for obtaining the credential. Herein, it should be illustrated that in an embodiment, the terminal may be pre-configured with the DNN information, herein, the provisioning server for providing the SNPN credential is located in the DNN indicated by the DNN information, or the DNN information is provided to the terminal by the ONN during the login process. In an embodiment, the trigger for the terminal to initiate the PDU session establishment procedure to retrieve the SNPN credential is dependent on the terminal, e.g., the PDU session establishment procedure is initiated based on the information input to the terminal by the user. After receiving the first PDU session establishment request message sent by the terminal, the base station may send the first PDU session establishment request message to the AMF.

Herein, the base station may also send the first PDU session establishment request message to the AMF.

It should be illustrated that the methods provided in the embodiments of the present disclosure may be performed separately or together with some of the methods in the embodiments of the present disclosure or some of the methods in the related arts, which can be understood by those skilled in the art.

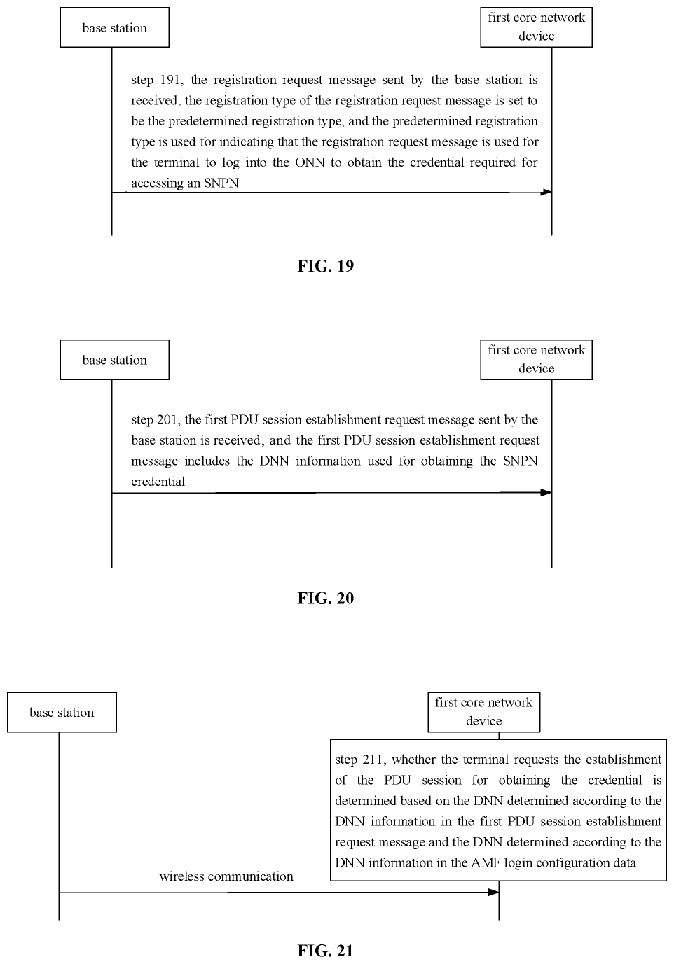

As shown in FIG. 19, a credential transmission method is provided in this embodiment. The method is performed by a first core network device, and includes step 191. At step 191, the registration request message sent by the base station is received.

Herein, the registration type of the registration request message is set to be the predetermined registration type, and the predetermined registration type is used for indicating that the registration request message is used for the terminal to log into the ONN to obtain the credential required for accessing an SNPN.

Herein, the first core network device may be an AMF entity.

In an embodiment, after receiving the registration request message, the AMF may initiate the procedure for authenticating the terminal to the AUSF entity in the ONN. Herein, the AMF login configuration data may restrict that the terminal network is only capable of requesting the distribution of the SNPN credential at the user plane.

It should be illustrated that the methods provided in the embodiments of the present disclosure may be performed separately or together with some of the methods in the embodiments of the present disclosure or some of the methods in the related arts, which can be understood by those skilled in the art.

As shown in FIG. 20, a credential transmission method is provided in this embodiment. The method is performed by a first core network device, and includes step 201.

At step 201, the first PDU session establishment request message sent by the base station is received. The first PDU session establishment request message includes the DNN information used for obtaining the SNPN credential.

Herein, the first core network device may be an AMF entity.

In an embodiment, after the terminal has successfully logged into the ONN, if the terminal requires to receive the SNPN credential from the ONN, the PDU session establishment procedure may be initiated. Herein, initiating the PDU session establishment procedure may be to send the first PDU session establishment request message to the base station in the ONN, herein, the first PDU session establishment request message includes the DNN information used for obtaining the credential. Herein, it should be illustrated that in an embodiment, the terminal may be pre-configured with the DNN information, herein, the provisioning server for providing the SNPN credential is located in the DNN indicated by the DNN information, or the DNN information is provided to the terminal by the ONN during the login process. In an embodiment, the trigger for the terminal to initiate the PDU session establishment procedure to retrieve the SNPN credential is dependent on the terminal, e.g., the PDU session establishment procedure is initiated based on the information input to the terminal by the user. After receiving the first PDU session establishment request message sent by the terminal, the base station may send the first PDU session establishment request message to the AMF.

It should be illustrated that the methods provided in the embodiments of the present disclosure may be performed separately or together with some of the methods in the embodiments of the present disclosure or some of the methods in the related arts, which can be understood by those skilled in the art.

As shown in FIG. 21, a credential transmission method is provided in this embodiment. The method is performed by a first core network device, and includes step 211.

At step 211, whether the terminal requests the establishment of the PDU session for obtaining the credential is determined based on the DNN determined according to the DNN information in the first PDU session establishment request message and the DNN determined according to the DNN information in the AMF login configuration data.

Herein, the first core network device may be an AMF entity.

In an embodiment, in response to the DNN determined according to the DNN information in the first PDU session establishment request message not matching with the DNN determined according to the DNN information in the AMF login configuration data, the first PDU session establishment request message is rejected; or, in response to the DNN determined according to the DNN information in the first PDU session establishment request message matching with the DNN determined according to the DNN information in the AMF login configuration data, the SMF entity connected to the DNN is determined.

It should be illustrated that the methods provided in the embodiments of the present disclosure may be performed separately or together with some of the methods in the embodiments of the present disclosure or some of the methods in the related arts, which can be understood by those skilled in the art.

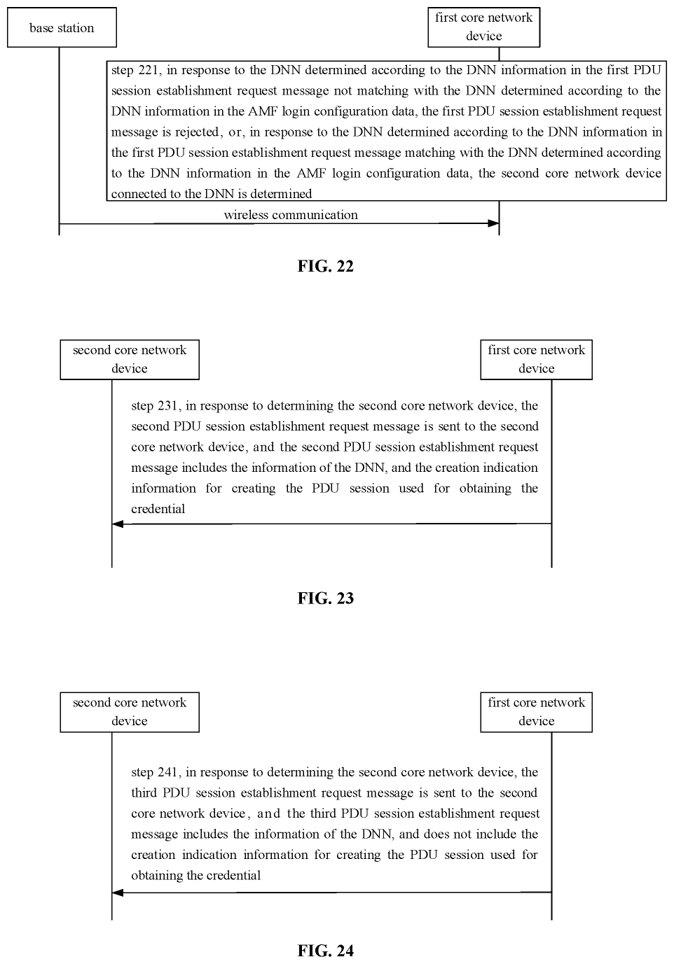

As shown in FIG. 22, a credential transmission method is provided in this embodiment. The method is performed by a first core network device, and includes step 221.

At step 221, in response to the DNN determined according to the DNN information in the first PDU session establishment request message not matching with the DNN determined according to the DNN information in the AMF login configuration data, the first PDU session establishment request message is rejected.

Alternatively, in response to the DNN determined according to the DNN information in the first PDU session establishment request message matching with the DNN determined according to the DNN information in the AMF login configuration data, the second core network device connected to the DNN is determined.

Herein, the first core network device may be an AMF entity, and the second core network device may be an SMF entity.

In an embodiment, rejecting the PDU session establishment request message may be performing other operations without responding to the PDU session establishment request message.

It should be illustrated that the methods provided in the embodiments of the present disclosure may be performed separately or together with some of the methods in the embodiments of the present disclosure or some of the methods in the related arts, which can be understood by those skilled in the art.

As shown in FIG. 23, a credential transmission method is provided in this embodiment. The method is performed by a first core network device, and includes step 231.

At step 231, in response to determining the second core network device, the second PDU session establishment request message is sent to the second core network device. The second PDU session establishment request message includes the information of the DNN, and the creation indication information for creating the PDU session used for obtaining the credential.

Herein, the first core network device may be an AMF entity, and the second core network device may be an SMF.

In an embodiment, after the SMF entity connected to the DNN is selected, the second PDU session establishment request message may be sent to the SMF entity. The second PDU session establishment request message includes the information of the DNN and the creation indication information for creating the PDU session for obtaining the credential. After receiving the second PDU session establishment request message, the SMF entity may configure, based on the creation indication information, the security policy information of the PDU session to be created for obtaining the credential to be indicative of the first target state. The first target state is a state indicative of performing the user plane security protection. Herein, the first target state may be a “require” state that requires the security protection for the DRB of the terminal.

It should be illustrated that the methods provided in the embodiments of the present disclosure may be performed separately or together with some of the methods in the embodiments of the present disclosure or some of the methods in the related arts, which can be understood by those skilled in the art.

As shown in FIG. 24, a credential transmission method is provided in this embodiment. The method is performed by a first core network device, and includes step 241.

At step 241, in response to determining the second core network device, the third PDU session establishment request message is sent to the second core network device. The third PDU session establishment request message includes the information of the DNN, and does not include the creation indication information for creating the PDU session used for obtaining the credential.

Herein, the first core network device may be an AMF entity, and the second core network device may be an SMF.

In an embodiment, after connecting to the SMF entity of the DNN, the third PDU session establishment request message may be sent to the SMF. The third PDU session establishment request message includes the information of the DNN and does not include the creation indication information for creating the PDU session used for obtaining the credential. After receiving the third PDU session establishment request message, the SMF entity may determine the security policy information of the PDU session based on the DNN determined according to the DNN information in the third PDU session establishment request message and the DNN determined according to the DNN information configured in the SMF. In an embodiment, in response to the DNN determined according to the information of the DNN in the third PDU session establishment request message matching with the DNN determined according to the DNN information configured in the SMF, the security policy information of the PDU session to be created for obtaining the credential may be configured to be indicative of the first target state. Alternately, in another embodiment, in response to the DNN determined according to the information of the DNN in the third PDU session establishment request message not matching with the DNN determined according to the DNN information configured in the SMF, the security policy information of the PDU session to be created for obtaining the credential may be configured to be indicative of the second target state. Herein, the first target state is a state indicative of performing the user plane security protection.

It should be illustrated that the methods provided in the embodiments of the present disclosure may be performed separately or together with some of the methods in the embodiments of the present disclosure or some of the methods in the related arts, which can be understood by those skilled in the art.

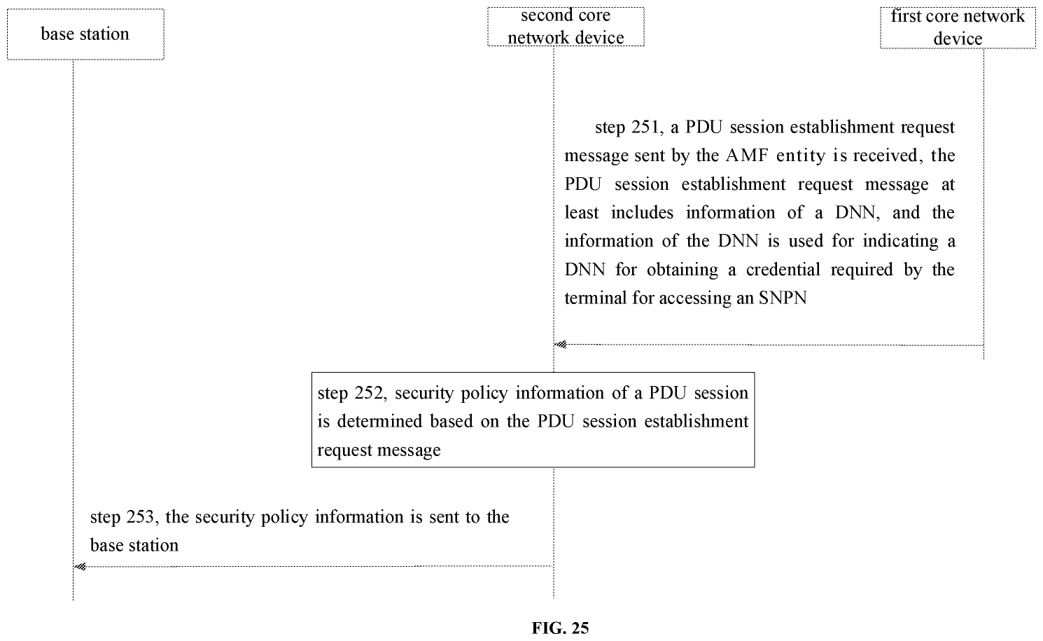

As shown in FIG. 25, a credential transmission method is provided in this embodiment. The method is performed by a second core network device, and includes steps 251 to 253.

At step 251, a PDU session establishment request message sent by the first core network device is received. The PDU session establishment request message at least includes information of a DNN, and the information of the DNN is used for indicating a DNN for obtaining a credential required by the terminal for accessing an SNPN.

At step 252, security policy information of a PDU session is determined based on the PDU session establishment request message.

At step 253, the security policy information is sent to the base station.

Herein, the second core network device may be an SMF entity, and the first core network device may be an AMF entity.

In an embodiment, the PDU session establishment request message may be the second PDU session establishment request message or the third PDU session establishment request message. The second PDU session establishment request message includes the information of the DNN and the creation indication information for creating the PDU session used for obtaining the credential. The third PDU session establishment request message includes the information of the DNN and does not include the creation indication information for creating the PDU session used for obtaining the credential.

It should be illustrated that the methods provided in the embodiments of the present disclosure may be performed separately or together with some of the methods in the embodiments of the present disclosure or some of the methods in the related arts, which can be understood by those skilled in the art.

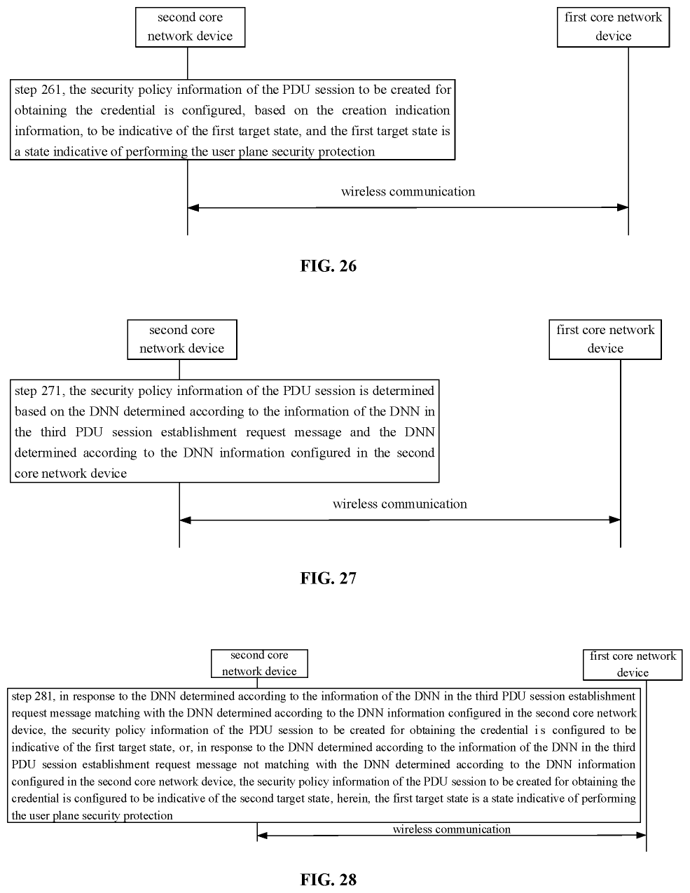

As shown in FIG. 26, a credential transmission method is provided in this embodiment. The method is performed by a second core network device, and includes step 261.

At step 261, the security policy information of the PDU session to be created for obtaining the credential is configured, based on the creation indication information, to be indicative of the first target state. The first target state is a state indicative of performing the user plane security protection.

Herein, the second core network device may be an SMF entity.

After receiving the second PDU session establishment request message, the SMF entity may configure, based on the creation indication information, the security policy information of the PDU session to be created for obtaining the credential to be indicative of the first target state. The first target state is a state indicative of performing the user plane security protection. Herein, the first target state may be a “require” state that requires the security protection for the DRB of the terminal.

It should be illustrated that the methods provided in the embodiments of the present disclosure may be performed separately or together with some of the methods in the embodiments of the present disclosure or some of the methods in the related arts, which can be understood by those skilled in the art.

As shown in FIG. 27, a credential transmission method is provided in this embodiment. The method is performed by a second core network device, and includes step 271.

At step 271, the security policy information of the PDU session is determined based on the DNN determined according to the information of the DNN in the third PDU session establishment request message and the DNN determined according to the DNN information configured in the second core network device.

Herein, the second core network device may be an SMF entity.

After receiving the third PDU session establishment request message, the SMF entity may determine the security policy information of the PDU session based on the DNN determined according to the DNN information in the third PDU session establishment request message and the DNN determined according to the DNN information configured in the SMF. In an embodiment, in response to the DNN determined according to the information of the DNN in the third PDU session establishment request message matching with the DNN determined according to the DNN information configured in the SMF, the security policy information of the PDU session to be created for obtaining the credential may be configured to be indicative of the first target state. Alternately, in another embodiment, in response to the DNN determined according to the information of the DNN in the third PDU session establishment request message not matching with the DNN determined according to the DNN information configured in the SMF, the security policy information of the PDU session to be created for obtaining the credential may be configured to be indicative of the second target state. Herein, the first target state is a state indicative of performing the user plane security protection.

It should be illustrated that the methods provided in the embodiments of the present disclosure may be performed separately or together with some of the methods in the embodiments of the present disclosure or some of the methods in the related arts, which can be understood by those skilled in the art.

As shown in FIG. 28, a credential transmission method is provided in this embodiment. The method is performed by a second core network device, and includes step 281.

At step 281, in response to the DNN determined according to the information of the DNN in the third PDU session establishment request message matching with the DNN determined according to the DNN information configured in the second core network device, the security policy information of the PDU session to be created for obtaining the credential is configured to be indicative of the first target state.

Alternatively, in response to the DNN determined according to the information of the DNN in the third PDU session establishment request message not matching with the DNN determined according to the DNN information configured in the second core network device, the security policy information of the PDU session to be created for obtaining the credential is configured to be indicative of the second target state. Herein, the first target state is a state indicative of performing the user plane security protection.

Herein, the second core network device may be an SMF entity.

In an embodiment, if the DNN indicated by the information of the DNN in the third PDU session establishment request message is the same as the DNN indicated by the DNN information configured in the SMF, the DNNs are determined to match with each other. Alternatively, if the DNN indicated by the information of the DNN in the third PDU session establishment request message is not the same as the DNN indicated by the DNN information configured in the SMF, the DNNs are determined to not match with each other.

Herein, the second target state is a state in which the user plane security policy information determined by the SMF based on the particular service as requested is set to be indicative of a state corresponding to a particular option, which may be a state that requires or does not require the user plane security protection.

It should be illustrated that the methods provided in the embodiments of the present disclosure may be performed separately or together with some of the methods in the embodiments of the present disclosure or some of the methods in the related arts, which can be understood by those skilled in the art.

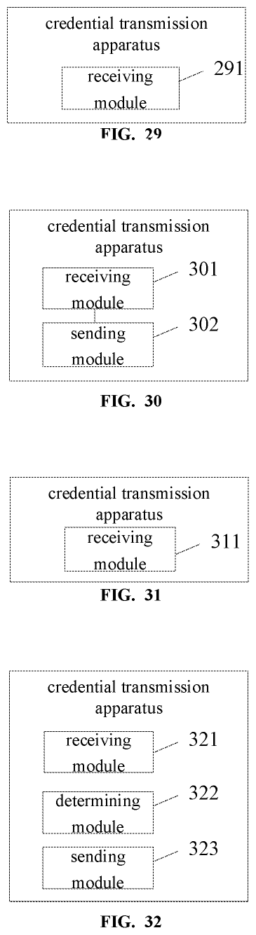

As shown in FIG. 29, a credential transmission apparatus is provided in this embodiment. The apparatus includes a receiving module 291.

The receiving module 291 is configured to receive the first indication information sent by the base station.

The first indication information is used for indicating that the user plane security protection operation of a DRB of the terminal is requested to be activated or not to be activated. The DRB is at least used for bearing a credential required by the terminal for accessing an SNPN.

It should be illustrated that the methods provided in the embodiments of the present disclosure may be performed separately or together with some of the methods in the embodiments of the present disclosure or some of the methods in the related arts, which can be understood by those skilled in the art.

As shown in FIG. 30, a credential transmission apparatus is provided in this embodiment. The apparatus includes a receiving module 301 and a sending module 302.

The receiving module 301 is configured to receive the security policy information sent by the second core network device.

The sending module 302 is configured to send to the terminal the first indication information determined based on the security policy information.

The first indication information is used for indicating that the user plane security protection operation of a DRB of the terminal is requested to be activated or not to be activated. The DRB is at least used for bearing a credential required by the terminal for accessing an SNPN.

It should be illustrated that the methods provided in the embodiments of the present disclosure may be performed separately or together with some of the methods in the embodiments of the present disclosure or some of the methods in the related arts, which can be understood by those skilled in the art.

As shown in FIG. 31, a credential transmission apparatus is provided in this embodiment. The apparatus includes a receiving module 311.

The receiving module 311 is configured to receive the registration request message sent by the base station.

The registration type of the registration request message is set to be the predetermined registration type. The predetermined registration type is used for indicating that the registration request message is used for the terminal to log into the ONN to obtain a credential required by the terminal for accessing an SNPN.

It should be illustrated that the methods provided in the embodiments of the present disclosure may be performed separately or together with some of the methods in the embodiments of the present disclosure or some of the methods in the related arts, which can be understood by those skilled in the art.

As shown in FIG. 32, a credential transmission apparatus is provided in this embodiment. The apparatus includes a receiving module 321, a determining module 322 and a sending module 323.

The receiving module 321 is configured to receive the PDU session establishment request message sent by the first core network device. The PDU session establishment request message at least includes the information of a DNN, and the information of the DNN is used for indicating a DNN for obtaining a credential required by the terminal for accessing an SNPN.

The determining module 322 is configured to determine, based on the PDU session establishment request message, the security policy information of the PDU session.

The sending module 323 is configured to send the security policy information to the base station.

It should be illustrated that the methods provided in the embodiments of the present disclosure may be performed separately or together with some of the methods in the embodiments of the present disclosure or some of the methods in the related arts, which can be understood by those skilled in the art.

An embodiment of the present disclosure provides a communication device. The communication device includes a processor and a memory configured to store an executable instruction executable by the processor.

The processor, when being used for executing the executable instruction, is configured to implement the method described in any embodiment of the present disclosure.

The processor may include various types of storage media that are non-transitory computer storage media capable of continuing to memorize information stored therein after the communication device is powered down.

The processor may be connected to the memory via a bus or the like for reading the executable program stored in the memory.

An embodiment of the present disclosure also provides a computer storage medium. The computer storage medium stores a computer executable program. The executable program, when executed by a processor, implements the method described in any embodiment of the present disclosure.

With respect to the apparatus of the above embodiments, the specific manner in which each module performs the operation has been described in detail in the embodiments relating to the method, and will not be described in detail herein.

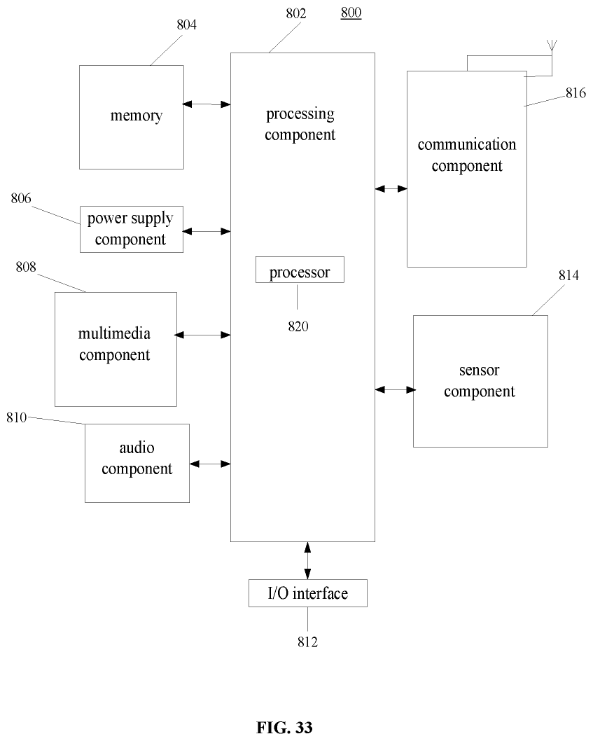

As shown in FIG. 33, an embodiment of the present disclosure provides a structure of a terminal.

Referring to the terminal 800 shown in FIG. 33, this embodiment provides a terminal 800, which specifically may be a mobile phone, a computer, a digital broadcast terminal, a message transceiver device, a game console, a tablet device, a medical device, a fitness device, a personal digital assistant, and the like.

Referring to FIG. 33, the terminal 800 may include one or more of the following components: a processing component 802, a memory 804, a power supply component 806, a multimedia component 808, an audio component 810, an input/output (I/O) interface 812, a sensor component 814, and a communication component 816.

The processing component 802 generally controls the overall operation of the terminal 800, such as operations associated with display, telephone calls, data communication, camera operations, and recording operations. The processing component 802 may include one or more processors 820 to execute an instruction to complete all or some of the steps of the methods described above. In addition, the processing component 802 may include one or more modules that facilitate interaction between the processing component 802 and other components. For example, the processing component 802 may include a multimedia module to facilitate interaction between the multimedia component 808 and the processing component 802.

The memory 804 is configured to store various types of data to support the operations at the terminal 800. Examples of such data include the following for any application program or method to operate on the terminal 800: instructions, contact data, phonebook data, messages, pictures, videos, etc. The memory 804 may be implemented by any type of volatile or non-volatile storage device or a combination thereof, such as a static random access memory (SRAM), electrically erasable programmable read-only memory (EEPROM), erasable programmable read-only memory (EPROM), programmable read-only memory (PROM), read-only memory (ROM), magnetic memory, flash memory, disk, or CD-ROM.

The power supply component 806 supplies power to various components of the terminal 800. The power supply component 806 may include a power supply management system, one or more power supplies, and other components associated with generating, managing, and distributing power for the terminal 800.

The multimedia component 808 includes a screen that provides an output interface between the terminal 800 and a user. In some embodiments, the screen may include a liquid crystal display (LCD) and a touch panel (TP). If the screen includes a touch panel, the screen may be implemented as a touch screen to receive input signals from the user. The touch panel includes one or more touch sensors to sense touches, swipes, and gestures on the touch panel. The touch sensor may not only sense the boundaries of the touch or swipe action, but also detect the duration and pressure associated with the touch or swipe action. In some embodiments, the multimedia component 808 includes a front-facing camera and/or a rear-facing camera. The front-facing camera and/or the rear-facing camera may receive external multimedia data when the terminal 800 is in an operating mode, such as a shooting mode or a video mode. Each of the front-facing camera and the rear-facing camera may be a fixed optical lens system or have a focal length and optical zoom capability.

The audio component 810 is configured to output and/or input audio signals. For example, the audio component 810 includes a microphone (MIC), configured to receive external audio signals when the terminal 800 is in an operating mode, such as a calling mode, a recording mode, and a voice recognition mode. The received audio signals may be further stored in the memory 804 or sent via the communication component 816. In some embodiments, the audio component 810 further includes a speaker for outputting the audio signals.

The I/O interface 812 provides an interface between the processing component 802 and a peripheral interface module, and the peripheral interface module may be a keypad, a click wheel, a button, etc. These buttons may include, but are not limited to, a home button, a volume button, a start button, and a lock button.

The sensor component 814 includes one or more sensors configured to provide a status assessment of various aspects of the terminal 800. For example, the sensor component 814 may detect an open/closed state of the terminal 800, relative positioning of the components, for example, the components are the display and small keypad of the terminal 800, the sensor component 814 may also detect a change in the position of the terminal 800 or a change in the position of one component of the terminal 800, the presence or absence of user contact with the terminal 800, the orientation or acceleration/deceleration of the terminal 800, and temperature changes of the terminal 800. The sensor component 814 may include a proximity sensor that is configured to detect the presence of nearby objects in the absence of any physical contact. The sensor component 814 may also include a light sensor, such as a CMOS or CCD image sensor, for use in imaging applications. In some embodiments, the sensor component 814 may also include an accelerometer sensor, a gyroscope sensor, a magnetic sensor, a pressure sensor, or a temperature sensor.

The communication component 816 is configured to facilitate the communication between the terminal 800 and other devices by wired or wireless means. The terminal 800 may access a wireless network based on a communication standard, such as Wi-Fi, 2G, 3G, or a combination thereof. In an embodiment, the communication component 816 receives broadcast signals or broadcast-related information from an external broadcast management system via a broadcast channel. In an embodiment, the communication component 816 further includes a near-field communication (NFC) module to facilitate short-range communication. For example, the NFC module may be implemented based on radio frequency identification (RFID) technology, infrared data association (IrDA) technology, ultra-wideband (UWB) technology, Bluetooth (BT) technology, and the like.

In an example or embodiment, the terminal 800 may be implemented by one or more of: an application-specific integrated circuit (ASIC), a digital signal processor (DSP), a digital signal processing device (DSPD), a programmable logic device (PLD), a field-programmable gate array (FPGA), a controller, a microcontroller, a microprocessor, or other electronic element, to perform the above methods.

In an example or embodiment, a non-transitory computer-readable storage medium including an instruction is provided, such as the memory 804 including an instruction. The instruction described above is capable of being executed by the processor 820 of the terminal 800 to complete the above methods. For example, the non-transitory computer-readable storage medium may be a ROM, a random access memory (RAM), a CD-ROM, a magnetic tape, a floppy disk, an optical data storage device, etc.

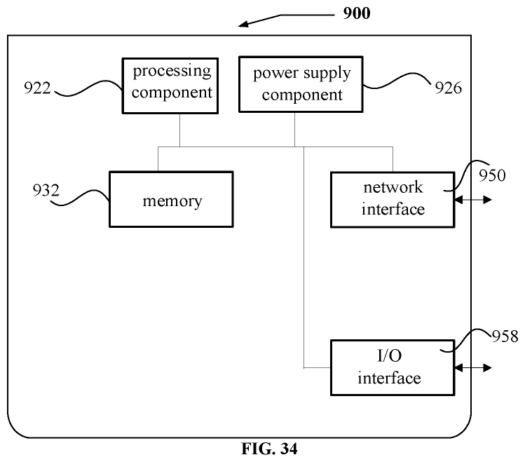

As shown in FIG. 34, an embodiment of the present disclosure illustrates a structure of a base station. For example, the base station 900 may be provided as a network side device. Referring to FIG. 34, the base station 900 includes a processing component 922. The processing component 922 further includes one or more processors, and a memory resource represented by a memory 932 for storing instructions, such as an application program, that may be executable by the processing component 922. The application program stored in the memory 932 may include one or more modules each corresponding to a set of instructions. In addition, the processing component 922 is configured to execute the instructions to perform any method described above applied to the base station.

The base station 900 may further include a power supply component 926 configured to perform power management of the base station 900, a wired or wireless network interface 950 configured to connect the base station 900 to a network, and an I/O interface 958. The base station 900 may operate an operating system stored in the memory 932, such as Windows Server™, Mac OS X™, Unix™, Linux™, FreeBSD™, or the like.

After considering the specification and practicing the disclosure disclosed herein, those skilled in the art will easily come up with other implementation solutions of the present disclosure. The present disclosure is intended to cover any variations, uses, or adaptive changes of the present disclosure, which follow the general principles of the present disclosure and include common knowledge or commonly used technical means in the technical field that are not disclosed in the present disclosure. The specification and embodiments are only considered to be illustrative, and the true scope and spirit of the present disclosure are indicated by the following claims.

It should be understood that the present disclosure is not limited to the precise structure which has been described above and illustrated in the accompanying drawings, and that various modifications and alterations may be made without departing from the scope of the present disclosure. The scope of the present disclosure is limited only by the appended claims.

1. A credential transmission method, comprising:
receiving, by a terminal, first indication information sent by a base station; wherein
the first indication information is used for indicating that a user plane security protection operation of a data radio bearer (DRB) of the terminal is requested to be activated or not to be activated; and the DRB is at least used for bearing a credential required by the terminal for accessing a stand-alone non-public network (SNPN).

2. The method according to claim 1, wherein the user plane security protection operation comprises at least one of integrity protection or encryption.

3. The method according to claim 1, wherein the receiving the first indication information sent by the base station comprises:
receiving a radio resource control (RRC) connection reconfiguration message carrying the first indication information sent by the base station.

4. The method according to claim 3, further comprising:
verifying the RRC connection reconfiguration message, and obtaining a result of the verifying; and
determining, based on the first indication information in response to the result of the verifying indicating that the verifying is successful, whether to activate the user plane security protection operation of the DRB of the terminal.

5. (canceled)

6. The method according to claim 4, further comprising:
rejecting the RRC connection reconfiguration message in response to the first indication information indicating that the user plane security protection operation of the DRB of the terminal is requested not to be activated; or
in response to the first indication information indicating that the user plane security protection operation of the DRB of the terminal is requested to be activated, accepting the RRC connection reconfiguration message, and performing the user plane security protection operation.

7. The method according to claim 6, further comprising:
sending an RRC connection reconfiguration completion message to the base station.

8. The method according to claim 1, wherein the base station is in an onboarding network (ONN), and the method further comprises:
sending second indication information to the base station during an RRC connection establishment process, wherein the second indication information is used for indicating that an RRC connection being established is used for the terminal to log into the ONN.

9. The method according to claim 8, further comprising:
sending, in response to the terminal initiating registration to the ONN, a registration request message to the base station; wherein
a registration type of the registration request message is set to be a predetermined registration type; and the predetermined registration type is used for indicating that the registration request message is used for logging into the ONN to obtain the credential.

10. The method according to claim 9, further comprising:
initiating, in response to the terminal logging into the ONN successfully and requiring to receive the credential via the ONN, a protocol data unit (PDU) session establishment procedure; wherein
the initiating the PDU session establishment procedure comprises:
sending a first PDU session establishment request message to the base station, wherein the first PDU session establishment request message carries digital data network (DNN) information used for obtaining the credential.

11. (canceled)

12. A credential transmission method, comprising:
receiving, by a base station, security policy information sent by a second core network device; and
sending, by the base station and to a terminal, first indication information determined based on the security policy information; wherein
the first indication information is used for indicating that a user plane security protection operation of a data radio bearer (DRB) of the terminal is requested to be activated or not to be activated; and the DRB is at least used for bearing a credential required by the terminal for accessing a stand-alone non-public network (SNPN). 13-14. (Cancelled)

15. The method according to claim 12, further comprising:
initiating, in response to sending a radio resource control (RRC) connection reconfiguration message to the terminal, a user plane security protection operation of a DRB of the base station.

16. The method according to claim 12, further comprising:
receiving second indication information sent by the terminal during an RRC connection establishment process, wherein the second indication information is used for indicating that an RRC connection being established is used for the terminal to log into an onboarding network (ONN); and
determining, in response to receiving the second indication information, a first core network device used for supporting the terminal to log into the ONN; wherein
the first core network device is configured with access control and mobility management function (AMF) login configuration data; and
the AMF login configuration data comprises at least one of: digital data network (DNN) information used for obtaining the credential, or information restricting the terminal to only be configured to request to obtain the credential.

17. (canceled)

18. The method according to claim 167, further comprising:
receiving a registration request message sent by the terminal, wherein a registration type of the registration request message is set to be a predetermined registration type; and the predetermined registration type is used for indicating that the registration request message is used for logging into the ONN to obtain the credential; and
sending the registration request message to the first core network device.

19. (canceled)

20. The method according to claim 189, further comprising:
receiving a first protocol data unit (PDU) session establishment request message sent by the terminal, wherein the first PDU session establishment request message comprises DNN information used for obtaining the credential; and
sending the first PDU session establishment request message to the first core network device.

21. (canceled)

22. A credential transmission method, comprising:
receiving, by a first core network device, a registration request message sent by a base station; wherein
a registration type of the registration request message is set to be a predetermined registration type; and the predetermined registration type is used for indicating that the registration request message is used for a terminal to log into an onboarding network (ONN) to obtain a credential required by the terminal for accessing a stand-alone non-public network (SNPN).

23. The method according to claim 22, further comprising:
initiating, in response to receiving the registration request message, a procedure for authenticating the terminal to an authentication service function (AUSF) in the ONN.

24. The method according to claim 23, further comprising:
receiving a first protocol data unit (PDU) session establishment request message sent by the base station, wherein the first PDU session establishment request message comprises digital data network (DNN) information used for obtaining the credential; and
determining, based on a DNN determined according to the DNN information in the first PDU session establishment request message and a DNN determined according to DNN information in access control and mobility management function (AMF) login configuration data, whether the terminal requests an establishment of a PDU session for obtaining the credential.

25. (canceled)

26. The method according to claim 24, wherein the determining whether the terminal requests the establishment of the PDU session for obtaining the credential comprises:
rejecting, in response to the DNN determined according to the DNN information in the first PDU session establishment request message not matching with the DNN determined according to the DNN information in the AMF login configuration data, the first PDU session establishment request message; or
determining, in response to the DNN determined according to the DNN information in the first PDU session establishment request message matching with the DNN determined according to the DNN information in the AMF login configuration data, a second core network device connected to the DNN.

27. The method according to claim 26, further comprising:
sending, in response to determining the second core network device, a second PDU session establishment request message to the second core network device, wherein the second PDU session establishment request message carries information of the DNN, and creation indication information for creating the PDU session used for obtaining the credentials; or
sending, in response to determining the second core network device, a third PDU session establishment request message to the second core network device, wherein the third PDU session establishment request message carries information of the DNN, and does not carry creation indication information for creating the PDU session used for obtaining the credential.

28-36. (canceled)

37. A communication device, comprising:
a memory; and
a processor, connected to the memory, and configured to perform, through executing a computer-executable instruction stored in the memory, the credential transmission method according to claim 1.

38. (canceled)
